(19) United States
(12) Patent Application Publication
(10) Pub. No.: US 2016/0378003 A1
(43) Pub. Date: Dec. 29, 2016

(54) MAGNETIC TONER, IMAGE FORMING APPARATUS, AND IMAGE FORMING METHOD

(71) Applicant: CANON KABUSHIKI KAISHA, Tokyo (JP)

(72) Inventors: Satoshi Arimura, Toride-shi (JP); Yusuke Hasegawa, Suntou-gun (JP); Tomohisa Sano, Mishima-shi (JP); Yoshitaka Suzumura, Mishima-shi (JP); Kozue Uratani, Mishima-shi (JP); Yuujirou Nagashima, Susono-shi (JP)

(21) Appl. No.: 15/191,707

(22) Filed: Jun. 24, 2016

(30) Foreign Application Priority Data
Jun. 29, 2015 (JP) 2015-129382

(51) Int. Cl. G03G 9/08; G03G 15/09; G03G 9/083

(52) U.S. Cl. CPC G03G 9/0819; G03G 9/0836; G03G 15/09

(57) ABSTRACT

Provided is a toner having improved durability. The magnetic toner includes magnetic toner particles each containing a binder resin and a magnetic material, in which a deformation amount when a load of 9.8×10⁻⁴ N is applied to one particle of the magnetic toner in a microcompression test is 3.0 μm or less, in which the magnetic toner has a surface free energy of 5 mJ/m² or more and 20 mJ/m² or less, and in which the magnetic toner has a melt viscosity η′ at 100° C. of 5.0×10³ Pa·s or more and 1.0×10⁵ Pa·s or less.

### BACKGROUND OF THE INVENTION

Field of the Invention

The present invention relates to a magnetic toner to be used in, for example, an electrophotographic method, an electrostatic recording method, or a magnetic recording method.

Description of the Related Art

A magnetic one-component contact development system, which is advantageous in terms of downsizing of an apparatus and an increase in image quality, has been investigated, and in particular, a cleaner-less system, which is advantageous for the downsizing, has been investigated. The cleaner-less system is free of a cleaning blade and a cleaner container, and hence enables significant downsizing of an apparatus.

In order to establish such apparatus, a toner excellent in development durability is required.

Hitherto, there have been proposed many approaches to improving the development durability of a toner. For example, in Japanese Patent Application Laid-Open No. 2010-145549, there is a disclosure of a toner having its durability particularly under a high-temperature and high-humidity environment improved by reducing a toner displacement amount with respect to application of a load.

In addition, in Japanese Patent Application Laid-Open No. 2011-47989, an investigation has been made from the viewpoint of triboelectric chargeability, and there has been proposed a technology involving controlling surface free energy of a toner.

### SUMMARY OF THE INVENTION

Although the technologies as described above have been known, there has been a need for a toner capable of stably providing an excellent image even when image formation on a larger number of sheets is performed. In particular, there has been a need for a toner which enables satisfactory image formation over a long period of time even when image formation is performed by a magnetic one-component contact development system in which large mechanical stress is applied to the toner. According to one embodiment of the present invention, there is provided a magnetic toner having improved durability. Through the use of the magnetic toner of the present invention, a clear image in which the occurrence of a ghost, fogging, or the like is suppressed can be obtained even after image formation on a large number of sheets.

In order to solve the above-mentioned problems, according to one embodiment of the present invention, there is provided a magnetic toner, including magnetic toner particles each containing a binder resin and a magnetic material,

in which a deformation amount when a load of 9.8×10⁻⁴N is applied to one particle of the magnetic toner in a microcompression test is 3.0 μm or less,

in which the magnetic toner has a surface free energy of 5 mJ/m² or more and 20 mJ/m² or less, and

in which the magnetic toner has a melt viscosity η′ at 100° C. of 5.0×10³ Pa·s or more and 1.0×10⁵ Pa·s or less.

According to another embodiment of the present invention, there is provided an image forming method or an image forming apparatus using the above-mentioned magnetic toner.

According to the present invention, the magnetic toner having improved durability can be provided. Through the use of such magnetic toner, a clear image in which the occurrence of a ghost, fogging, or the like is suppressed can be obtained even after image formation on a large number of sheets.

Further features of the present invention will become apparent from the following description of exemplary embodiments with reference to the attached drawings.

### BRIEF DESCRIPTION OF THE DRAWINGS

FIG. 1 is an example of a method of measuring a surface layer based on a cross-section of a toner particle.

FIG. 2A is an example of a system in which a stirring device to be suitably used in the present invention is incorporated into a circulation line.

FIG. 2B is an example of a side view of the main body of the system in which the stirring device to be suitably used in the present invention is incorporated into the circulation line.

FIG. 3A is an example of a cross-sectional view of the stirring device to be suitably used in the present invention.

FIG. 3B is an example of a cross-sectional view of the stirring device to be suitably used in the present invention.

FIG. 3C is an example of a perspective view of a rotator of the stirring device to be suitably used in the present invention.

FIG. 3D is an example of a perspective view of a stator of the stirring device to be suitably used in the present invention.

FIG. 4A is an example of a developing unit.

FIG. 4B is an example of an image forming apparatus.

### DESCRIPTION OF THE EMBODIMENTS

Preferred embodiments of the present invention will now be described in detail in accordance with the accompanying drawings.

A magnetic toner is hereinafter sometimes referred to simply as “toner”.

The toner of the present invention is a magnetic toner, including magnetic toner particles each containing a binder resin and a magnetic material,

in which a deformation amount when a load of 9.8×10⁻⁴ N is applied to one particle of the magnetic toner in a microcompression test is 3.0 μm or less,

in which the magnetic toner has a surface free energy of 5 mJ/m² or more and 20 mJ/m² or less, and

in which the magnetic toner has a melt viscosity η′ at 100° C. of 5.0×10³ Pa·s or more and 1.0×10⁵ Pa·s or less.

According to the inventors of the present invention, a toner excellent in durability is obtained through the use of the above-mentioned toner. Through the use of such toner, a clear image in which the occurrence of a ghost, fogging, or the like is suppressed can be obtained even after image formation on a large number of sheets.

In magnetic one-component development, the magnetic toner is conveyed by being carried on a toner bearing member. In addition, the magnetic toner passes through a portion abutting against a regulating member (hereinafter referred to as “regulating portion”), and thus the coat layer thickness of the magnetic toner carried on the toner bearing member is regulated. In addition, when the magnetic toner passes through the regulating portion, replacement between a toner present on the surface of the toner layer and a toner present inside occurs. During this movement, the toner is triboelectrically charged through rubbing with the regulating member and the toner bearing member.

Accordingly, in the case of a toner which is liable to aggregate when subjected to mechanical stress, the replacement of toners hardly occurs, and hence stable triboelectric charging is difficult.

Particularly when a toner bearing member having a small diameter is used, the abutting pressure of the regulating member is increased. Consequently, aggregation of the toner is liable to occur, and hence stable triboelectric charging is difficult. Further, when development is performed by a contact development system, the toner is further subjected to mechanical stress, and hence is required to have higher durability.

The toner of the present invention has a lower surface free energy value than that of a relate-art toner. The surface free energy refers to energy for reducing the surface area of a substance. Accordingly, when the surface free energy is high, coalescence or aggregation of particles is liable to be promoted. In contrast, when the surface free energy is low, the coalescence or aggregation of particles is not promoted and the particles are likely to be independently present as they are. Therefore, when the surface free energy of the toner is reduced, the adhesive force of the toner for a member and the adhesive force between the particles of the toner can be reduced. As a result, the replacement of toners easily occurs and the triboelectric charging of the toner is stably performed.

In addition, when the toner is liable to deform, the pressure applied to the toner at the regulating portion causes deformation of the toner. In this case, the number of occasions of contact, and a contact area, between toner particles and between the toner and a member in the vicinity of the toner are increased, and thus the replacement of toners as described above hardly occurs. Accordingly, the deformation of the toner needs to be suppressed to some extent.

The inventors of the present invention have made extensive investigations, and as a result, have obtained the finding that when a deformation amount when an applied load of 9.8×10⁻⁴ N is applied to one particle of the toner in a microcompression test is 3.0 μm or less, and the toner has a surface free energy of 5 mJ/m² or more and 20 mJ/m² or less, satisfactory replacement performance of the toner is obtained. In addition, a toner which satisfies the above-mentioned specifications can suppress excess contact between toner particles and between the toner and a member in the vicinity of the toner. In addition, such toner has a small deformation amount and high resistance against stress, and hence can maintain excellent properties even after undergoing image formation on a large number of sheets.

When the surface free energy of the toner is set to 20 mJ/m² or less, as described above, the adhesive force of the toner can be reduced and the aggregation of the toner at the regulating portion can be suppressed. However, when the surface free energy is less than 5 mJ/m², the adhesive force is excessively reduced to destabilize the coating of the toner bearing member with the toner, resulting in image defects, such as a reduction in image density and a ghost.

The aggregation-suppressing effect becomes more remarkable when the toner particles have an aspect ratio (minor axis/major axis) of 0.88 or more and 1.00 or less.

In addition, in the present invention, it is important that the toner have a melt viscosity η′ at 100° C. of 5.0×10³ Pa·s or more and 1.0×10⁵ Pa·s or less. When the melt viscosity η′ falls within the range, satisfactory low-temperature fixability can be achieved.

In the case where the melt viscosity η′ is less than 5.0×10³ Pa·s, the fastness of the toner is reduced, with the result that deterioration of the toner in a developing unit cannot be sufficiently suppressed. The case where the melt viscosity η′ is more than 1.0×10⁵ Pa·s is not preferred because a high temperature setting is required in a fixing step, which tends to result in poor energy saving performance.

That is, the toner of the present invention is a toner having both development durability and low-temperature fixability. A toner which satisfies the specifications of the present invention can be achieved by controlling the surface state of the toner particles or the presence state of the magnetic material, or by controlling the crosslinked structure of the binder resin. In addition, the properties of the toner are also influenced by the kind and presence state of an external additive being present on the surface of the toner particles.

The state of the surface of the toner particles is preferably controlled by allowing an organosilicon polymer having a partial structure represented by the following formula (T3) to be present on the surface of the toner particles. The expression O_{1/2} means that two Si atoms are bonded to one oxygen atom and the number of oxygen atoms per Si atom is ½.

R—Si(O_{1/2})₃ (T3)

(In the formula (T3), R represents an alkyl group having 1 or more and 6 or less carbon atoms, or a phenyl group.)

Further, it is more preferred that, in ²⁹Si—NMR measurement of the tetrahydrofuran-insoluble matter of the toner particles, the ratio [ST3] of the peak area of the partial structure represented by the formula (T3) to the total peak area of the organosilicon polymer is 40% or more.

A shell is preferably formed by allowing a certain amount or more of the organosilicon polymer having the structure represented by the formula (T3) to be present on the surface of toner particles from the viewpoint of the ease of control of a toner displacement amount and the melt viscosity η′. The ratio of the organosilicon polymer having the structure represented by the formula (T3) may be controlled based on the kind and amount of an organosilicon compound to be used for the formation of the organosilicon polymer, and the reaction temperature, time, solvent, and pH of hydrolysis, addition polymerization, and condensation polymerization in the formation of the organosilicon polymer.

In addition, the suppression of exposure of a compound having a high water-absorbing property, such as a wax, through the formation of the shell also leads to a reduction in surface free energy of the toner.

In addition, the toner displacement amount may be controlled by controlling the presence state of the magnetic material inside of the toner particles.

Specifically, the toner displacement amount may be controlled by localizing the magnetic material to the vicinity of the surface of each of the toner particles. When the toner particles are produced in an aqueous medium, the toner displacement amount may be controlled by changing the conditions of hydrophobizing treatment of the magnetic material, and specifically, may be controlled by changing, for example, the kind of hydrophobizing treatment agent, a treatment amount, pH during the treatment, and a treatment method.

In addition, the toner more preferably has a dielectric loss factor (∈″) at a frequency of 100 kHz and a temperature of 30° C. of 0.05 pF/m or more and 0.25 pF/m or less. When the dielectric loss factor (∈″) falls within the range, leakage of charge of the toner can be suppressed, with the result that charge can be sufficiently imparted to the toner at the regulating portion. The dielectric loss factor (∈″) may be controlled by controlling the presence state of the magnetic material in the vicinity of the surface of the toner.

In addition, an external additive present on the surface of the toner particles influences the surface free energy of the toner. When a large amount of the external additive is used, the surface free energy can be lowered. In this case, however, a variation in developability may be increased when image formation on a large number of sheets is performed. Accordingly, a control method which does not depend on the external additive is preferred. When the shell of the organosilicon polymer having the structure represented by the formula (T3) is formed on the surface of the toner particles, the use amount of the external additive can be reduced or the use of the external additive is not required. Therefore, the formation of the shell is a method extremely preferred as means for controlling the physical properties specified in the present invention.

Now, the organosilicon polymer is described.

In the partial structure represented by the formula (T3), R more preferably represents an alkyl group having 1 to 3 carbon atoms from the viewpoint of controlling the hydrophobicity of the surface of the toner to achieve satisfactory environmental stability. Preferred examples of the alkyl group having 1 to 3 carbon atoms may include a methyl group, an ethyl group, and a propyl group. R still more preferably represents a methyl group from the viewpoints of environmental stability and storage stability.

Specifically, the organosilicon polymer present in the surface layer of the toner particles is preferably produced by hydrolysis polycondensation of a silicon compound typified by an alkoxysilane.

The organosilicon polymer having the partial structure represented by the formula (T3) is preferably an organosilicon polymer obtained by polymerizing an organosilicon compound having a structure represented by the following formula (Z).

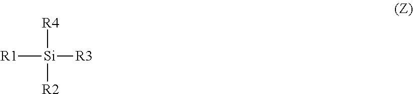

(In the formula (Z), R1 represents an alkyl group having 1 to 6 carbon atoms or a phenyl group, and R2, R3, and R4 each independently represent a halogen atom, a hydroxy group, an acetoxy group, or an alkoxy group.)

The presence of the substituent R1 can improve hydrophobicity to provide toner particles excellent in environmental stability. R1 preferably represents an alkyl group having 1 to 6 carbon atoms or a phenyl group. When the hydrophobicity of R1 is high, a variation in charge quantity tends to be increased in a wide range of environments. Accordingly, in view of environmental stability, R1 more preferably represents an alkyl group having 1 to 3 carbon atoms.

Preferred examples of the alkyl group having 1 to 3 carbon atoms may include a methyl group, an ethyl group, and a propyl group. In addition, another preferred example of R1 may be a phenyl group. In this case, satisfactory chargeability and fogging prevention are achieved. R1 still more preferably represents a methyl group from the viewpoints of environmental stability and storage stability.

R2 to R4 each represent a group having reactivity, which contributes to the formation of a crosslinked structure through hydrolysis, addition polymerization, and condensation polymerization. From the viewpoints of mild hydrolyzability at room temperature, and properties of precipitating on, and covering, the surface of the toner, R2 to R4 each represent preferably an alkoxy group, more preferably a methoxy group or an ethoxy group.

In addition, in the present invention, the content of the organosilicon polymer in the toner particles is preferably 0.50 mass % or more and 50.00 mass % or less, more preferably 0.75 mass % or more and 40.00 mass % or less.

Examples of the compound having the structure represented by the formula (Z) include the following compounds.

Trifunctional methylsilanes, such as methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, and methyldiethoxyhydroxysilane.

Trifunctional silanes, such as ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, and hexyltrihydroxysilane.

Trifunctional phenylsilanes, such as phenyltrimethoxysilane, phenyltriethoxysilane, phenyltrichlorosilane, phenyltriacetoxysilane, and phenyltrihydroxysilane.

The content of the unit structure represented by the formula (T3) is preferably 50 mol % or more, more preferably 60 mol % or more with reference to all constituent silicon atoms in the organosilicon polymer. When the content of the T unit structure represented by the formula (T3) is set to 50 mol % or more, the environmental stability of the toner can be further improved.

In addition, in the present invention, as long as the effects of the present invention are not impaired, the organosilicon compound having the T unit structure represented by the formula (T3) may be used in combination with an organosilicon compound having four reaction groups per molecule (tetrafunctional silane), an organosilicon compound having two reaction groups per molecule (bifunctional silane), or an organosilicon compound having one reaction group per molecule (monofunctional silane). Examples of the organosilicon compound which may be used in combination include the following organosilicon compounds.

Dimethyldiethoxysilane, tetraethoxysilane, hexamethyldisilazane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropylmethyldiethoxysilane, 3-methacryloxypropyltriethoxysilane, 3-acryloxypropyltrimethoxysilane, 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, 3-phenylaminopropyltrimethoxysilane, 3-anilinopropyltrimethoxysilane, 3-mercaptopropylmethyldimethoxysilane, 3-mercaptopropyltrimethoxysilane, 3-mercaptopropyltriethoxysilane, 3-glycidoxypropyltrimethoxysilane, 3-glycidoxypropylmethyldimethoxysilane, 3-glycidoxypropylmethyldiethoxysilane, hexamethyldisilane, tetraisocyanatesilane, methyltriisocyanatesilane, t-butyldimethylchlorosilane, t-butyldimethylmethoxysilane, t-butyldimethylethoxysilane, t-butyldiphenylchlorosilane, t-butyldiphenylmethoxysilane, t-butyldiphenylethoxysilane, chloro(decyl)dimethylsilane, methoxy(decyl)dimethylsilane, ethoxy(decyl)dimethylsilane, chlorodimethylphenylsilane, methoxydimethylphenylsilane, ethoxydimethylphenylsilane, chlorotrimethylsilane, methoxytrimethylsilane, ethoxytrimethylsilane, triphenylchlorosilane, triphenylmethoxysilane, triphenylethoxysilane, chloromethyl(dichloro)methylsilane, chloromethyl(dimethoxy)methylsilane, chloromethyl(diethoxy)methylsilane, di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, dichloro(methyl)-n-octylsilane, dimethoxy(methyl)-n-octylsilane, and diethoxy(methyl)-n-octylsilane.

In general, it is known that, in a sol-gel reaction, the bonding state of a siloxane bond to be generated varies depending on the acidity of a reaction medium. Specifically, when the reaction medium is acidic, a hydrogen ion is electrophilically added to oxygen of one reaction group (for example, an alkoxy group (—OR group)). Then, an oxygen atom in a water molecule is coordinated to a silicon atom to become a hydrosilyl group through a substitution reaction. When water exists sufficiently, one H⁺ attacks one oxygen of the reaction group (for example, an alkoxy group (—OR group)). Therefore, when the content of H⁺ in the reaction medium is small, the substitution reaction to a hydroxy group becomes slow. Thus, a polycondensation reaction occurs before all the reaction groups bonded to silane are subjected to hydrolysis, with the result that a one-dimensional linear polymer or a two-dimensional polymer is generated relatively easily.

Meanwhile, when the reaction medium is alkaline, a hydroxide ion is added to silicon to form a five-coordinated intermediate. Therefore, all the reaction groups (for example, alkoxy groups (—OR groups)) are easily detached to be easily substituted by a silanol group. In particular, when a silicon compound having three or more reaction groups is used in the same silane, hydrolysis and polycondensation occur three-dimensionally, to thereby form an organosilicon polymer containing a large number of three-dimensional crosslinking bonds. Further, the reaction is finished within a short period of time.

Thus, in order to form an organosilicon polymer, it is preferred that the sol-gel reaction proceed in the reaction medium under an alkaline state. When an organosilicon polymer is produced in an aqueous medium, specifically, it is preferred that the reaction proceed under the condition of a pH of 8.0 or more. With this, an organosilicon polymer having higher strength and being excellent in durability can be formed. In addition, the sol-gel reaction is preferably performed at a reaction temperature of 90° C. or more and for a reaction time of 5 hours or more.

When the sol-gel reaction is performed at the above-mentioned reaction temperature and for the above-mentioned reaction time, the formation of coalesced particles resulting from bonding between molecules of the silane compound in a sol or gel state on the surface of the toner particles can be suppressed.

Further, as long as the effects of the present invention are not impaired, an organotitanium compound or an organoaluminum compound may be used together with the organosilicon compound.

Examples of the organotitanium compound include the following compounds: titanium methoxide, titanium ethoxide, titanium n-propoxide, tetra-i-propoxytitanium, tetra-n-butoxytitanium, titanium isobutoxide, titanium butoxide dimer, titanium tetra-2-ethylhexoxide, titanium diisopropoxy bis(acetylacetonate), titanium tetracetylacetonate, titanium di-2-ethylhexoxy bis(2-ethyl-3-hydroxyhexoxide), titanium diisopropoxy bis(ethyl acetoacetate), tetrakis(2-ethylhexyloxy)titanium, di-i-propoxy.bis(acetylacetonato)titanium, titanium lactate, titanium methacrylate isopropoxide, triisopropoxytitanate, titanium methoxypropoxide, and titanium stearyl oxide.

Examples of the organoaluminum compound include the following compounds: aluminum(III) n-butoxide, aluminum(III) s-butoxide, aluminum(III) s-butoxide bis(ethyl acetoacetate), aluminum(III) t-butoxide, aluminum(III) di-s-butoxide ethylacetoacetate, aluminum(III) diisopropoxide ethylacetoacetate, aluminum(III) ethoxide, aluminum(III) ethoxyethoxyethoxide, aluminum hexafluoropentanedionate, aluminum(III) 3-hydroxy-2-methyl-4-pyronate, aluminum(III) isopropoxide, aluminum-9-octadecenyl acetoacetate diisopropoxide, aluminum(III) 2,4-pentanedionate, aluminum phenoxide, and aluminum(III) 2,2,6,6-tetramethyl-3,5-heptanedionate.

One kind of those compounds may be used alone, or two or more kinds thereof may be used. A charge quantity may be adjusted by appropriately combining those compounds or changing the amount(s) of the compound(s) to be added.

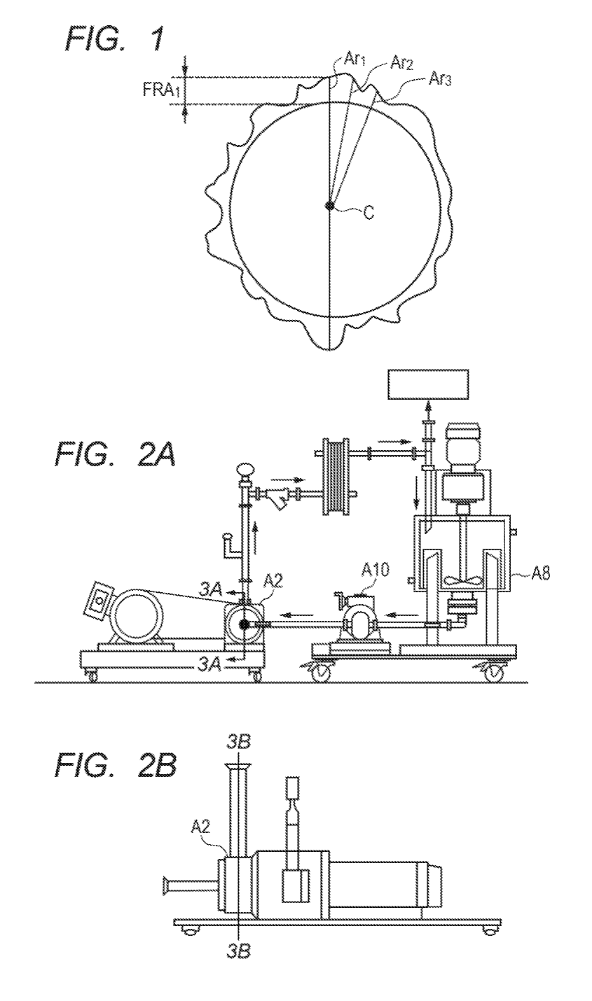

In the present invention, in the observation of a cross-section of one of the toner particles using a transmission electron microscope (TEM), when: a midpoint of a major axis L is defined as a center; the cross-section of the toner particle is equally divided into 32 parts; and dividing axes drawn from the center to the surface of the toner particle are defined as Arₙ (n=1 to 32), respectively, an average thickness Dav. of the surface layer containing the organosilicon polymer of the toner particle for 32 points on the dividing axes is preferably 5.0 nm or more and 150.0 nm or less (see FIG. 1). In the present invention, the surface layer containing the organosilicon polymer and a portion other than the surface layer (so-called core portion) are preferably in contact with each other without any gap. With this, the surface layer containing the organosilicon polymer of each of the toner particles can uniformly cover the toner particle, and hence a toner excellent in storage stability, environmental stability, and development durability can be obtained. From the viewpoint of storage stability, the average thickness Dav. of the surface layer of the toner particles is more preferably 7.5 nm or more and 125.0 nm or less, still more preferably 10.0 nm or more and 100.0 nm or less.

The average thickness Day. of the surface layer of the toner particles may be controlled based on the number of carbon atoms of the hydrocarbon group in the formula (Z) and the number of hydrophilic groups therein, and the reaction temperature, reaction time, reaction solvent, and pH of addition polymerization and condensation polymerization in the formation of the organosilicon polymer. In addition, the average thickness Dav. may also be controlled based on the content of the organosilicon polymer. Further, the average thickness Dav. is also influenced by a production method for the toner particles.

In addition, the ratio of the number of dividing axes at which the thickness of the surface layer containing the organosilicon polymer of the toner particles is 5.0 nm or less, the ratio being determined by a method to be described later (hereinafter sometimes referred to as “ratio at which the surface layer has a thickness of 5.0 nm or less”), is preferably 20.0% or less, more preferably 10.0% or less, still more preferably 5.0% or less (see FIG. 1).

When the ratio at which the surface layer has a thickness of 5.0 nm or less falls within the above-mentioned range, the surface layer containing the organosilicon polymer of each of the toner particles can uniformly cover the toner particle, and hence a toner excellent in storage stability, environmental stability, and development durability can be obtained.

Now, components to be contained in the toner other than the organosilicon polymer are described.

As the binder resin for forming the toner, a resin known as a binder resin for a toner may be used without any limitation. For example, a styrene-acrylic resin or a polyester resin may be used. When the toner particles are produced by a suspension polymerization method, a polymer produced by polymerization of a polymerizable monomer to be described later serves as the binder resin.

A releasing agent is preferably contained as one of the constituent materials of the toner particles. Examples of the releasing agent which may be used for the toner particles include: petroleum-based waxes, such as a paraffin wax, a microcrystalline wax, and petrolatum, and derivatives thereof; a Montan wax and derivatives thereof; a hydrocarbon wax produced by a Fischer-Tropsch process and derivatives thereof; polyolefin waxes, such as polyethylene and polypropylene, and derivatives thereof; natural waxes, such as a carnauba wax and a candelilla wax, and derivatives thereof; higher aliphatic alcohols; fatty acids, such as stearic acid and palmitic acid, or compounds, acid amide waxes, ester waxes, or ketones thereof; a hydrogenated castor oil and derivatives thereof; plant waxes; animal waxes; and silicone resins. The derivatives include oxides, and block copolymerization products or graft-modified products with vinyl-based monomers.

The content of the releasing agent is preferably from 5.0 parts by mass to 20.0 parts by mass with respect to 100.0 parts by mass of the binder resin or the polymerizable monomer.

Next, the magnetic material to be suitably used for the toner of the present invention is described.

The toner particles in the present invention each contain the magnetic material. The magnetic material to be used for the toner of the present invention is preferably a treated magnetic material obtained by subjecting magnetic iron oxide to surface treatment with a silane compound. This is because it is preferred to subject the magnetic material to hydrophobizing treatment during production by a suspension polymerization method to be preferably used for the control of the dispersibility of the magnetic material.

The dielectric loss factor (∈″) of the magnetic toner may be controlled by controlling the presence state of the magnetic material in the vicinity of the surface of the toner. In order to increase the value of the dielectric loss factor (∈″), it is appropriate to cause the magnetic material to be present on the surface of the toner or in the vicinity of the surface. Through an increase in amount of the magnetic material, which has lower resistance than that of a resin, on the surface of the toner or in the vicinity of the surface, charge is easily dissipated. Meanwhile, in order to lower the value of the dielectric loss factor (∈″), it is appropriate to reduce the amount of the magnetic material present in the surface layer of the toner, and to that end, it is appropriate to disperse the magnetic material across the inside of the toner.

The magnetic material preferably has a surface subjected to hydrophobizing treatment. Silane coupling agents are available as compounds to be suitably used for the hydrophobizing treatment, and of those, an alkylalkoxysilane represented by the following formula (1) is preferably used after being subjected to hydrolysis treatment.

CₚH₂ₚ₊₁—Si—(OC_{q}H_{2q+1})₃ Formula (1)

[In the formula, p represents an integer of from 2 to 20, and q represents an integer of from 1 to 3.]

When the alkoxysilane is hydrolyzed, an end thereof is converted into a OH group, resulting in an increased affinity for a OH group present on the surface of an untreated magnetic material. As a result, the treatment agent is easily adsorbed onto the surface of the untreated magnetic material, and hence can sufficiently cover the surface. As a result, an untreated portion hardly remains.

Therefore, from the viewpoint of satisfying treatment uniformity and sufficient hydrophobicity, p in the formula (1) preferably represents 2 or more and 20 or less, and p represents more preferably 4 or less, particularly preferably 3 or more and 4 or less. When p represents 3 or more, hydrophobicity can be sufficiently imparted to the magnetic material, and at the same time, by virtue of the large number of molecules of the treatment agent which can be adsorbed per unit area, the uniformity of the surface of the treated magnetic material is further increased. In addition, when p represents 4 or less, the density of the treatment agent on the surface of the magnetic material is also kept to be high. That is, when p represents 3 or more and 4 or less, the hydrophobicity and the treatment uniformity can be both achieved. In addition, in the production of the magnetic toner in an aqueous medium, the magnetic material can be distributed in the vicinity of the surface of the magnetic toner. With regard to q, from the viewpoint of increasing the reactivity of the alkylalkoxysilane to sufficiently perform the hydrophobizing treatment, an alkyltrialkoxysilane in which q represents an integer of from 1 to 3 (more preferably an integer of 1 or 2) is preferably used.

For the purpose of controlling the dielectric loss factor to be low, a technique involving highly dispersing the magnetic material in each of the toner particles is available, and to that end, it is preferred to use a plurality of magnetic materials different from each other in hydrophobicity.

Further, it is preferred that magnetic iron oxide containing silicon be used as the magnetic material and its surface be subjected to hydrophobizing treatment with a silane compound. With this, the affinity between the surface of the magnetic iron oxide and the silane compound is improved, and the uniformity of the treatment with the silane compound is further improved.

The number-average diameter of primary particles of the magnetic material is preferably 150 nm or more and 220 nm or less from the viewpoint of, while suppressing aggregation between molecules of the magnetic material in the binder resin, densely localizing the magnetic material in the surface layer of the toner, to thereby improve durability and storage stability. In addition, the content of the magnetic material in the toner of the present invention is preferably from 50 parts by mass to 110 parts by mass with respect to 100 parts by mass of the binder resin from the viewpoints of low-temperature fixability and heat-resistant storage stability.

In the present invention, the toner particles may each contain a charge control agent. As the charge control agent, a known one may be used. In particular, a charge control agent having high charging speed and being capable of stably maintaining a constant charge quantity is preferred. Further, when the toner particles are produced by a direct polymerization method, a charge control agent having a low polymerization inhibiting property and being substantially free of solubilized matter in an aqueous medium is particularly preferred.

Examples of the charge control agent which controls toner particles so that the particles may be negatively chargeable include the following agents: as organometallic compounds and chelate compounds, a monoazo metal compound, an acetylacetone metal compound, and aromatic oxycarboxylic acid-, aromatic dicarboxylic acid-, oxycarboxylic acid-, and dicarboxylic acid-based metallic compounds. Other examples thereof include aromatic oxycarboxylic acids, and aromatic mono- and polycarboxylic acids, and metallic salts, anhydrides, or esters thereof, and phenol derivatives, such as bisphenol. In addition, there are given a urea derivative, a salicylic acid-based compound containing a metal, a naphthoic acid-based compound containing a metal, a boron compound, a quaternary ammonium salt, calixarene, and a polymer having a sulfonic acid-based functional group.

Meanwhile, examples of the charge control agent which controls toner particles so that the particles may be positively chargeable include the following agents: nigrosine and modified nigrosine compounds, such as a fatty acid metal salt thereof; a guanidine compound; an imidazole compound; quaternary ammonium salts, such as a tributylbenzylammonium-1-hydroxy-4-naphtosulfonate and tetrabutylammonium tetrafluoroborate, and onium salts which are analogs of the above-mentioned compounds, such as a phosphonium salt, and lake pigments thereof; a triphenylmethane dye and a lake pigment thereof (examples of a laking agent include phosphotungstic acid, phosphomolybdic acid, phosphotungstic molybdic acid, tannic acid, lauric acid, gallic acid, a ferricyanide, and a ferrocyanide); a metal salt of a higher fatty acid; and a resin-based charge control agent.

One kind of those charge control agents may each be contained alone, or two or more kinds thereof may be contained in combination. Of those charge control agents, a salicylic acid-based compound containing a metal is preferred, and the metal is particularly preferably aluminum or zirconium. The most preferred charge control agent is the compound aluminum 3,5-di-tert-butylsalicylate.

The addition amount of the charge control agent is preferably from 0.01 part by mass to 10.00 parts by mass with respect to 100.00 parts by mass of the binder resin or the polymerizable monomer.

The toner of the present invention may be provided as a toner by treating the surface of the toner particles with various organic fine powders or inorganic fine powders for the purpose of imparting various characteristics. The organic fine powder or the inorganic fine powder preferably has a particle diameter of 1/10 or less of the weight-average particle diameter of the toner particles in view of durability at the time of addition to the toner particles.

As the organic fine powder or the inorganic fine powder, the following powders are used. The powders are preferably treated with a hydrophobizing treatment agent (silane compound or silicone oil).

(1) Fluidity imparting agents: silica, alumina, titanium oxide, carbon black, and carbon fluoride.
(2) Abrasives: metal oxides, such as strontium titanate, cerium oxide, alumina, magnesium oxide, and chromium oxide, nitrides, such as silicon nitride, carbides, such as silicon carbide, and metal salts, such as calcium sulfate, barium sulfate, and calcium carbonate.
(3) Lubricants: fluorine-based resin powders, such as vinylidene fluoride and polytetrafluoroethylene, and fatty acid metal salts, such as zinc stearate and calcium stearate.
(4) Charge controllable particles: metal oxides, such as tin oxide, titanium oxide, zinc oxide, silica, and alumina, and carbon black.

The addition amount of the organic fine powder or the inorganic fine powder is preferably from 0.01 part by mass to 10.00 parts by mass, more preferably from 0.02 part by mass to 5.00 parts by mass, still more preferably from 0.03 part by mass to 1.00 part by mass with respect to 100.00 parts by mass of the toner particles. Through the optimization of the addition amount, embedding of the organic fine powder or the inorganic fine powder into the toner particles, and the occurrence of contamination of a member due to liberation of the powder from the toner particles can be further suppressed. One kind of those organic fine powders or inorganic fine powders may be used alone, or two or more kinds thereof may be used in combination.

The weight-average particle diameter (D4) of the toner of the present invention is preferably from 4.0 μm to 10.0 μm, more preferably from 5.0 μm to 10.0 μm, still more preferably from 6.0 μm to 9.0 μm.

The glass transition temperature (Tg) of the toner of the present invention is preferably from 35° C. to 100° C., more preferably from 40° C. to 80° C., still more preferably from 45° C. to 70° C. When the glass transition temperature falls within the range, storage stability and low-temperature fixability are both easily achieved.

Next, a production method for the toner particles is described.

Specific modes in which the organosilicon polymer is incorporated into the surface layer of the toner particles are described below, but the present invention is not limited thereto.

As a first production method, there is given a mode involving granulating a polymerizable monomer composition containing the organosilicon compound for forming the organosilicon polymer and a polymerizable monomer for forming the binder resin in an aqueous medium to polymerize the polymerizable monomer, to thereby provide the toner particles (hereinafter sometimes referred to as “suspension polymerization method”). As the aqueous medium, there may be used any of: water; alcohols, such as methanol, ethanol, and propanol; and mixed solvents thereof, and the same applies to other production methods.

As a second production method, there is given a mode involving: obtaining a base for the toner particles in advance; and then loading the base for the toner particles into an aqueous medium to form the surface layer of the organosilicon polymer on the base for the toner particles in the aqueous medium. The base for the toner particles may be any of:

(i) a base obtained by melt-kneading the binder resin, followed by pulverization;
(ii) a base obtained by aggregating binder resin particles in an aqueous medium, followed by association; and
(iii) a base obtained by suspending an organic phase dispersion liquid, which is produced by dissolving the binder resin in an organic solvent, in an aqueous medium, and granulating and polymerizing the resultant, followed by removal of the organic solvent.

As a third production method, there is given a mode involving: suspending an organic phase dispersion liquid, which is produced by dissolving the binder resin and the organosilicon compound for forming the organosilicon polymer in an organic solvent, in an aqueous medium; granulating and polymerizing the resultant; and then removing the organic solvent to provide the toner particles.

As a fourth production method, there is given a mode involving: aggregating binder resin particles and particles each containing the organosilicon compound for forming the organosilicon polymer in a sol or gel state in an aqueous medium; and associating the aggregate to form the toner particles.

As a fifth production method, there is given a mode involving: spraying a solvent containing the organosilicon compound for forming the organosilicon polymer onto the surface of a base for the toner particles by a spray-dry method; and polymerizing or drying the surface by hot air and cooling to form the organosilicon polymer in the surface layer of the toner particles.

The base for the toner particles may be any of:

(i) a base obtained by melt-kneading a binder resin, followed by pulverization;
(ii) a base obtained by aggregating binder resin particles in an aqueous medium, followed by association; and
(iii) a base obtained by suspending an organic phase dispersion liquid, which is produced by dissolving the binder resin in an organic solvent, in an aqueous medium, and granulating and polymerizing the resultant, followed by removal of the organic solvent.

The toner particles produced by each of those production methods have satisfactory environmental stability because the organosilicon polymer is formed in the vicinity of the surface of the toner particles. In addition, even under a severe environment, a change in surface state of the toner particles due to bleeding of the resin present inside of the toner particles or the releasing agent to be added as required is suppressed.

In the present invention, the obtained toner particles or toner may be subjected to surface treatment using hot air. When the toner particles or the toner is subjected to the surface treatment using hot air, the condensation polymerization of the organosilicon polymer in the vicinity of the surface of the toner particles can be promoted to improve environmental stability and development durability.

Of the above-mentioned production methods, the first production method, i.e., the suspension polymerization method is preferred as the production method for the toner particles of the present invention. In the suspension polymerization method, the organosilicon polymer is easily precipitated on the surface of the toner particles in a uniform manner, resulting in excellent adhesiveness between the surface layer and the inside, and satisfactory storage stability, environmental stability, and development durability.

The suspension polymerization method is further described below.

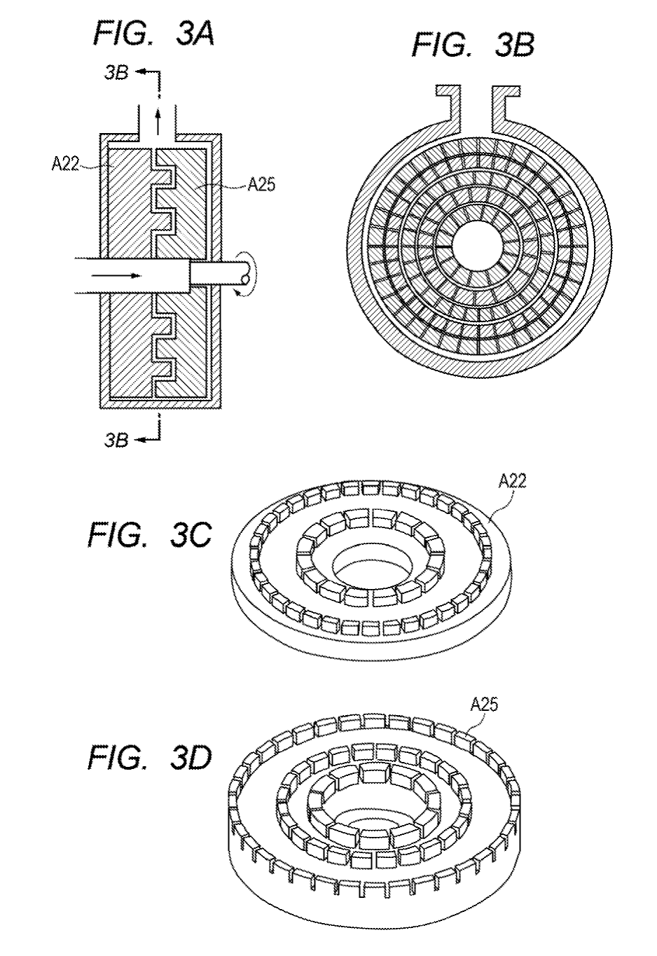

The suspension polymerization method preferably includes: a dispersion step of dispersing at least the magnetic material in the polymerizable monomer to provide a magnetic material-dispersed monomer; and a preparation step of mixing the resultant magnetic material-dispersed monomer with other necessary components, such as the releasing agent and a polar resin, to provide a polymerizable monomer composition. In addition, in each of the dispersion step and the preparation step, treatment is preferably performed using a stirring device in which a rotator having a ring shape with a plurality of slits, in which protrusions are formed concentrically in a multistage manner, and a stator having a similar shape are coaxially arranged so as to be mutually engaged while keeping a constant interval (see FIG. 2A, FIG. 2B, and FIG. 3A to FIG. 3D).

A system in which a stirring device having high shear force to be preferably used in each of the dispersion step and the preparation step of the present invention is incorporated into a circulation path is illustrated in FIG. 2A, and a side view of the main body of the stirring device is illustrated in FIG. 2B. However, the stirring device to be used in the present invention is not limited thereto. FIG. 3A and FIG. 3B are cross-sectional views of the main body of the stirring device, and are a cross-sectional view taken along the line 3A-3A of FIG. 2A and a cross-sectional view taken along the line 3B-3B of FIG. 2B, respectively. In addition, FIG. 3C and FIG. 3D are a perspective view of the rotator of the stirring device and a perspective view of the stator thereof, respectively.

Now, the stirring device is specifically described.

In FIG. 2A, the polymerizable monomer and at least the magnetic material are loaded into a holding tank A8 to provide a preparation liquid. The loaded preparation liquid is supplied from an inlet of the stirring device via a circulating pump A10. In the stirring device, the preparation liquid passes through slits of a rotator A25 and a stator A22 arranged in a casing A2 and is discharged in a centrifugal direction. When the preparation liquid passes through the stirring device, the preparation liquid is mixed and dispersed by an impact resulting from compression and ejection in the centrifugal direction resulting from shifts in the slits of the rotator and the stator, and an impact resulting from the shear between the rotator and the stator, to thereby provide the magnetic material-dispersed monomer (dispersion step). Further, the releasing agent is added to the magnetic material-dispersed monomer in the holding tank A8, and is similarly circulated between the stirring device and the holding tank A8 to be mixed and dispersed, to thereby provide the polymerizable monomer composition (preparation step).

The shape of each of the rotator and the stator to be used in the present invention is a ring shape with a plurality of slits, in which protrusions are formed concentrically in a multistage manner, and it is preferred that the rotator and the stator be coaxially arranged so as to be mutually engaged while keeping a constant interval. The shape in which the rotator and the stator are arranged so as to be mutually engaged reduces a short pass, to thereby allow the preparation liquid to be sufficiently dispersed. In addition, when the rotator and the stator are present alternately in a multistage manner in the concentric direction, the preparation liquid is subjected to many shears and impacts when proceeding in the centrifugal direction, and hence the dispersion level can be further increased. The holding tank A8 has a jacket structure, and hence a treated product can be cooled or heated. The circumferential speed of each of the rotator and the stator in the present invention refers to the circumferential speed of each of the rotator and the stator at its maximum diameter. In the present invention, when the circumferential speed of the rotator A25 is represented by G (m/s), the preparation liquid is preferably stirred by rotation under the condition of 20≦G≦60. It is more preferred that the circumferential speed G of the rotator satisfy 30≦G≦40. When the circumferential speed G of the rotator satisfies 20≦G≦60, the impact resulting from compression and ejection of the preparation liquid in the centrifugal direction resulting from shifts in the slits of the rotator and the stator, and the impact resulting from the shear between the rotator and the stator are increased, and hence a higher level of dispersion is achieved. With this, as compared to the related art, dispersion unevenness of the preparation liquid is extremely small, and a uniform dispersion state can be achieved. For example, Cavitron (manufactured by Eurotec) may be suitably used as the stirring device, but the stirring device is not limited thereto.

The polymerizable monomer composition obtained in the preparation step is subjected to a polymerization step serving as the next step, and the polymerizable monomer is polymerized in the polymerization step to produce particles. In addition, after the completion of the polymerization step, the produced particles are washed, collected by filtration, and dried to provide the toner particles. The temperature may be increased in the latter part of the polymerization step. Further, in order to remove an unreacted polymerizable monomer or a byproduct, part of the dispersion medium may be removed by evaporation from the reaction system in the latter part of the polymerization step or after the completion of the polymerization step.

Materials described below are not applied only to the suspension polymerization method, and may also be applied to any other production method described above.

Preferred examples of the polymerizable monomer may include the following vinyl-based polymerizable monomers: styrene; styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; acrylic polymerizable monomers, such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxy ethyl acrylate; methacrylic polymerizable monomers, such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters, such as vinyl acetate, vinyl propionate, vinyl benzoate, vinyl butyrate, vinyl benzoate, and vinyl formate; vinyl ethers, such as vinyl methyl ether, vinyl ethyl ether, and vinyl isobutyl ether; and vinyl methyl ketone, vinyl hexyl ketone, and vinyl isopropyl ketone.

In the polymerization of the polymerizable monomer, a polymerization initiator may be added. Examples of the polymerization initiator include: azo-based or diazo-based polymerization initiators, such as 2,2′-azobis-(2, 4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide-based polymerization initiators, such as benzoyl peroxide, methyl ethyl ketone peroxide, diisopropyl peroxycarbonate, cumene hydroperoxide, 2,4-dichlorobenzoyl peroxide, and lauroyl peroxide. Any such polymerization initiator is preferably added in an amount of from 0.5 mass % to 30.0 mass % with respect to the polymerizable monomer. One kind of those polymerization initiators may be used alone, or two or more kinds thereof may be used in combination.

In order to control the molecular weight of the binder resin forming the toner particles, a chain transfer agent may be added in the polymerization of the polymerizable monomer. The addition amount of the chain transfer agent is preferably 0.001 mass % to 15.000 mass % of the polymerizable monomer. In addition, with regard to a method of adding the polymerization initiator, the polymerization initiator may be added at once or in divided portions.

Meanwhile, in order to control the molecular weight of the binder resin forming the toner particles, a crosslinking agent may be added in the polymerization of the polymerizable monomer. Examples of the crosslinking agent include: divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, a polyester-type diacrylate (MANDA manufactured by Nippon Kayaku Co., Ltd.), and monomers obtained by changing the above-mentioned acrylates to methacrylates.

In addition, as a polyfunctional crosslinking agent, the following crosslinking agents are given: pentaerythritol triacrylate, trimethylolethane triacrylate, trimethylolpropane triacrylate, tetramethylolmethane tetraacrylate, oligoester acrylate, and methacrylates thereof, 2,2-bis(4-methacryloxy polyethoxyphenyl)propane, diallyl phthalate, triallyl cyanurate, triallyl isocyanurate, triallyl trimellitate, and diallyl chlorendate. The addition amount of the crosslinking agent is preferably from 0.001 part by mass to 15.000 parts by mass with respect to 100 parts by mass of the polymerizable monomer.

A preferred example of the polar resin to be incorporated into the polymerizable monomer composition may be a saturated or unsaturated polyester resin.

As the polyester resin, one obtained by subjecting a carboxylic acid and an alcohol exemplified below to condensation polymerization may be used.

Examples of the carboxylic acid include terephthalic acid, isophthalic acid, phthalic acid, fumaric acid, maleic acid, cyclohexanedicarboxylic acid, and trimellitic acid. Examples of the alcohol include bisphenol A, hydrogenated bisphenol, an ethylene oxide adduct of bisphenol A, a propylene oxide adduct of bisphenol A, glycerin, trimethylolpropane, and pentaerythritol.

The polyester resin may also be a polyester resin containing a urea group.

In the present invention, the weight-average molecular weight of the polar resin is preferably 4,000 or more and 100,000 or less. In addition, the content of the polar resin is preferably from 3.0 mass % to 70.0 mass %, more preferably from 3.0 mass % to 50.0 mass %, still more preferably from 5.0 mass % to 30.0 mass % with reference to the binder resin component contained in the toner particles.

When the medium to be used in the polymerization of the polymerizable monomer is an aqueous medium, the following may be used as a dispersion stabilizer for a particle of the polymerizable monomer composition in the aqueous medium.

As an inorganic dispersion stabilizer, there are given tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina.

In addition, as an organic dispersion stabilizer, there are given polyvinyl alcohol, gelatin, methylcellulose, methylhydroxypropylcellulose, ethylcellulose, carboxymethylcellulose sodium salt, and starch.

In addition, a commercially available nonionic, anionic, or cationic surfactant can also be utilized. Examples of the surfactant include sodium dodecyl sulfate, sodium tetradecyl sulfate, sodium pentadecyl sulfate, sodium octyl sulfate, sodium oleate, sodium lauryl sulfate, and potassium stearate.

In the present invention, when the aqueous medium is prepared using a poorly water-soluble inorganic dispersion stabilizer, the addition amount of the dispersion stabilizer is preferably from 0.2 part by mass to 2.0 parts by mass with respect to 100.0 parts by mass of the polymerizable monomer. In addition, the aqueous medium is preferably prepared using 300 to 3,000 parts by mass of water with respect to 100 parts by mass of the polymerizable monomer composition.

In the present invention, when the aqueous medium having dispersed therein a poorly water-soluble inorganic dispersant as described above is prepared, a commercially available dispersion stabilizer may be used as it is. In addition, in order to obtain a dispersion stabilizer having a fine uniform particle size, the poorly water-soluble inorganic dispersant may be produced in a liquid medium, such as water, under high-speed stirring. Specifically, when tricalcium phosphate is used as the dispersion stabilizer, a preferred dispersion stabilizer may be obtained by mixing an aqueous solution of sodium phosphate and an aqueous solution of calcium chloride under high-speed stirring to form fine particles of tricalcium phosphate.

Next, an image forming method (image forming apparatus) in which the toner of the present invention may be suitably used is described.

The toner of the present invention may be applied to an image forming method including an electrophotographic process as described below:

a charging step of charging a surface of an electrostatic latent image bearing member with a contact type charging roller;

an image exposing step of exposing the charged surface of the electrostatic latent image bearing member to form an electrostatic latent image;

a developing step of developing the electrostatic latent image with a magnetic toner to form a toner image;

a transfer step of transferring the toner image onto a transfer material through or without through an intermediate transfer member; and

a fixing step of fixing the toner image, transferred onto the transfer material, onto the transfer material.

In addition, the image forming method in which a cleaning step of removing a residual toner present on the surface of the electrostatic latent image bearing member after the transfer step and before the charging step is not included, and the residual toner is collected in the developing step may also be applied.

In addition, an image forming apparatus to which the above-mentioned image forming method may be applied may be exemplified by an apparatus having a configuration as described below:

a magnetic toner;

an electrostatic latent image bearing member;

a contact type charging roller configured to charge the electrostatic latent image bearing member;

an image exposing device configured to form an electrostatic latent image on a charged surface of the electrostatic latent image bearing member;

a developing device configured to develop the electrostatic latent image with the magnetic toner to form a toner image;

a transfer device configured to transfer the toner image onto a transfer material through or without through an intermediate transfer member; and

a fixing device configured to fix the toner image, transferred onto the transfer material, onto the transfer material.

In addition, the following configuration may be adopted: the image forming apparatus is free of a cleaning device configured to remove a transfer residual toner on the electrostatic latent image bearing member in a region downstream of the transfer device and upstream of the contact type charging roller along the surface of the electrostatic latent image bearing member, and the transfer residual toner is collected in the developing device.

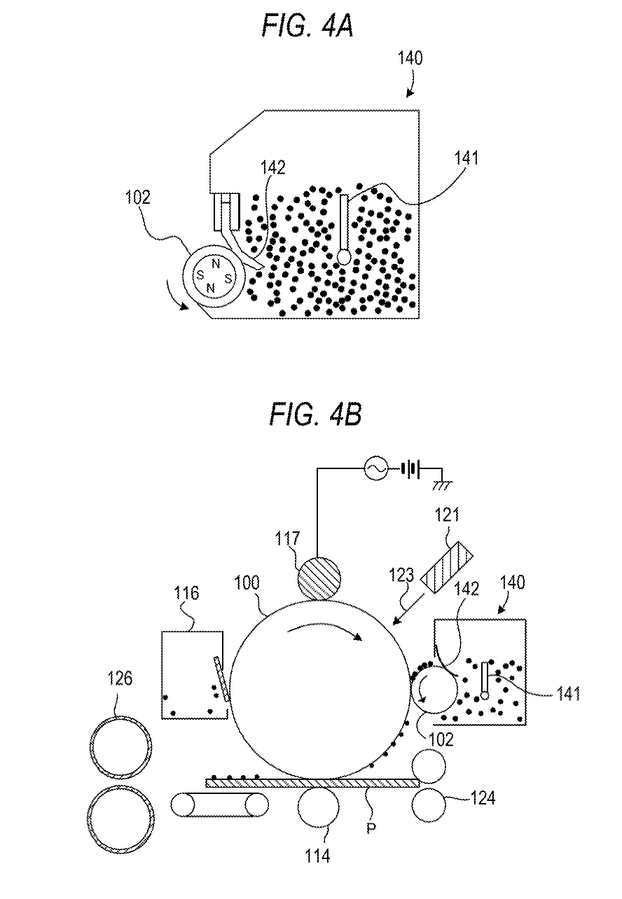

Next, an example of the image forming apparatus for which the toner of the present invention may be suitably used is specifically described with reference to FIG. 4A and FIG. 4B. FIG. 4A is an enlarged view of a developing unit, and FIG. 4B is a general view of an image forming apparatus including the developing unit. In FIG. 4A and FIG. 4B, around a photosensitive drum 100, there are arranged a primary charging roller 117, a developing unit 140 including a toner bearing member (developing sleeve) 102, a transfer roller 114, a cleaner 116, a registration roller 124, and the like. The developing unit 140 includes a regulating member 142 configured to regulate the thickness of a toner layer on the toner bearing member, and a stirring member 141 configured to stir a developer in the developing unit. The photosensitive drum 100 is charged by the primary charging roller 117 to, for example, −600 V (applied voltages are, for example, an AC voltage of 1.85 kVpp and a DC voltage of −620 Vdc). Then, exposure is performed by irradiating the photosensitive member 100 with laser light 123 from a laser-generating device 121, and thus an electrostatic latent image corresponding to an image of interest is formed. The electrostatic latent image on the photosensitive drum 100 is developed with a one-component toner by the developing unit 140 to provide a toner image, and the toner image is transferred onto a transfer material P by the transfer roller 114 abutting against the photosensitive member through the intermediation of the transfer material P. The transfer material P having placed thereon the toner image is transferred to a fixing unit 126 by a conveyance belt or the like, and the toner image is fixed onto the transfer material P. In addition, the toner partially left on the photosensitive member is cleaned off by the cleaner 116. The apparatus of FIG. 4A and FIG. 4B is configured such that the toner image is transferred onto the transfer material P without through an intermediate transfer member, but an apparatus configured such that the toner image is transferred through the intermediate transfer member may also be suitably used. In addition, the present invention may be suitably used also for a cleaner-less system free of the cleaner 116 arranged downstream of the transfer roller 114 and upstream of the charging roller 117.

<Isolation of Tetrahydrofuran (THF)-Insoluble Matter of Toner Particles>

The tetrahydrofuran (THF)-insoluble matter of the toner particles was isolated as described below.

10.0 g of the toner particles are weighed, loaded into a cylindrical paper filter (No. 86R manufactured by Toyo Roshi Kaisha, Ltd.) together with a magnetic stirrer, and subjected to a Soxhlet extractor. Extraction was performed for 20 hours using 200 mL of THF as a solvent, and the magnetic stirrer to which the magnetic material, which had been contained in each of the toner particles, adhered was removed. The residue in the cylindrical paper filter was vacuum-dried at 40° C. for several hours, and the resultant was used as the THF-insoluble matter of the toner particles for NMR measurement.

When the toner particles each have a surface treated with organic fine powder or inorganic fine powder, the toner particles are obtained by removing the organic fine powder or the inorganic fine powder by the following method.

16.0 g of ion-exchanged water and 4.0 g of Contaminon N (neutral detergent manufactured by Wako Pure Chemical Industries, Ltd., product No. 037-10361) are loaded into a 30 mL vial made of glass and sufficiently mixed. To the prepared solution, 1.50 g of the magnetic toner is added, and a magnet is brought closer from the bottom surface to settle all the magnetic toner. After that, the magnet is moved to remove air bubbles and to conform the magnetic toner to the solution.

An ultrasonic vibrator UH-50 (manufactured by SMT Corporation, using a titanium alloy tip having a tip diameter of 6 mm) is set so that its tip may be positioned at the central portion of the vial and may have a height of 5 mm from the bottom surface of the vial, followed by the removal of the inorganic fine powder (or the organic fine powder) by ultrasonic dispersion. After an ultrasonic wave has been applied for 30 minutes, the whole amount of the magnetic toner is removed and dried with a dryer for 1 hour or more. The dried product is disintegrated with a spatula to provide toner particles each containing the magnetic material.

<Identification Method for Partial Structure Represented by Formula (T3))>

The partial structure represented by the formula (T3) in the organosilicon polymer contained in the toner particles is identified by using the following method.

The presence or absence of an alkyl group and a phenyl group each represented by R of the formula (T3) was confirmed by ¹³C-NMR. In addition, the detailed structure of the formula (T3) was identified by ¹H-NMR, ¹³C-NMR, and ²⁹Si-NMR. An apparatus used and measurement conditions are shown below.
Measurement Condition
   Apparatus: AVANCE III 500 manufactured by Bruker Corporation

### Probe: 4 mm MAS BB/1H

Measurement temperature: room temperature
Sample rotation frequency: 6 kHz
Sample: 150 mg of the measurement sample (THF-insoluble matter of the toner particles for NMR measurement) was added into a sample tube with a diameter of 4 mm.

The presence or absence of an alkyl group and a phenyl group each represented by R of the formula (T3) was confirmed by the above-mentioned method. When a signal was found, it was determined that the structure represented by the formula (T3) was “present”.
Measurement Condition of ¹³C-NMR (solid)
   Measurement nuclear frequency: 125.77 MHz
   Reference substance: Glycine (external standard: 176.03 ppm)
   Width to be monitored: 37.88 kHz
   Measurement method: CP/MAS
   Contact period: 1.75 ms
   Repeated interval: 4 s
   Cumulative number: 2,048 times
   LB value: 50 Hz
Measurement Method of ²⁹Si-NMR (solid)
   Apparatus: AVANCE III 500 manufactured by Bruker Corporation

### Probe: 4 mm MAS BB/1H

Measurement temperature: room temperature
Sample rotation frequency: 6 kHz
Sample: 150 mg of the measurement sample (THF-insoluble matter of the toner particles for NMR measurement) is added into a sample tube with a diameter of 4 mm.
Measurement nuclear frequency: 99.36 MHz
Reference substance: DSS (external standard: 1.534 ppm)
Width to be monitored: 29.76 kHz
Measurement method: DD/MAS, CP/MAS
90-degree pulse width: 4.00 μs, −1 dB
Contact period: from 1.75 ms to 10 ms
Repeated interval: 30 s (DD/MASS), 10 s (CP/MAS)
Cumulative number: 2,048 times
LB value: 50 Hz

<Calculation Method for Ratio of Partial Structure Represented by Formula (T3) (T3 Structure) and Structure Having Number of O₁/2 Bonded to Silicon of 2.0 (X2 Structure) in Organosilicon Polymer Contained in Toner Particles>

### [Identification and Quantification Method for T3 Structure, X1 Structure, X2 Structure, X3 Structure, and X4 Structure]

The partial structures of T3, X1, X2, X3, and X4 may be identified by ¹H-NMR, ¹³C-NMR, and ²⁹Si-NMR.

After ²⁹Si-NMR measurement of the THF-insoluble matter of the toner particles, a plurality of silane components having different substituents and bonded groups in the toner particles are subjected to peak separation, through curve fitting, into an X4 structure represented by the following general formula (X4) having a number of O_{1/2} bonded to silicon of 4.0, an X3 structure represented by the following general formula (X3) having a number of O_{1/2} bonded to silicon of 3.0, an X2 structure represented by the following general formula (X2) having a number of O_{1/2} bonded to silicon of 2.0, an X1 structure represented by the following general formula (X1) having a number of O_{1/2} bonded to silicon of 1.0, and the T unit structure represented by the formula (T3), and mol % of each of the components is calculated from the area ratio of a peak corresponding to each of the components.

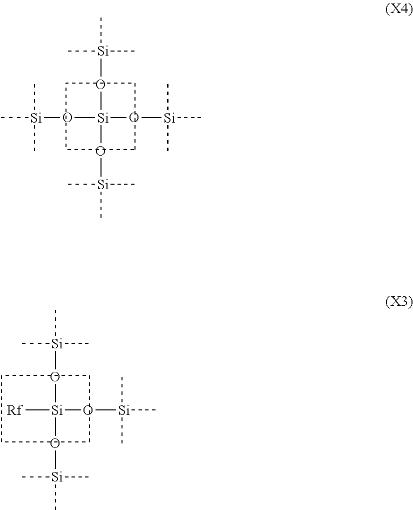

(Rf in the formula (X3) represents an organic group, a halogen atom, a hydroxy group, or an alkoxy group bonded to silicon.)

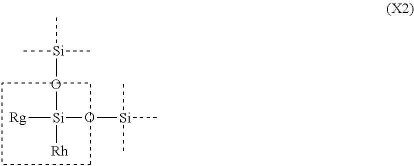

(Rg and Rh in the formula (X2) each represent an organic group, a halogen atom, a hydroxy group, or an alkoxy group bonded to silicon.)

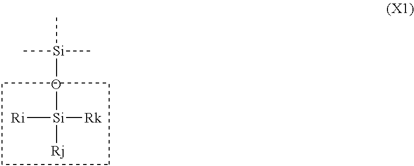

(Ri, Rj, and Rk in the formula (X1) each represent an organic group, a halogen atom, a hydroxy group, or an alkoxy group bonded to silicon.)

Software EXcalibur for Windows (trademark) version 4.2 (EX series) for JNM-EX400 manufactured by JEOL Ltd. is used for the curve fitting. Measurement data is opened by clicking “1D Pro” in menu icons. Next, “Curve fitting function” is selected from “Command” of a menu bar, and then curve fitting is performed. Peak separation is performed so that a peak of a synthesis peak difference that is a difference between a synthesis peak and a measurement result may become minimum.

An area for the X1 structure, an area for the X2 structure, an area for the X3 structure, and an area for the X4 structure are determined, and SX1, SX2, SX3, and SX4 are determined by the following formulae.

In the present invention, a silane monomer is identified by a chemical shift value, and in the ²⁹Si-NMR measurement of the toner particles, a total of the area for the X1 structure, the area for the X2 structure, the area for the X3 structure, and the area for the X4 structure calculated by subtracting the areas for the monomer components from a total peak area was defined as a total peak area for the organosilicon polymer.

SX1+SX2+SX3+SX4=1.00

SX1={area for X1 structure/(area for X1 structure+area for X2 structure+area for X3 structure+area for X4 structure)}
SX2={area for X2 structure/(area for X1 structure+area for X2 structure+area for X3 structure+area for X4 structure)}
SX3={area for X3 structure/(area for X1 structure+area for X2 structure+area for X3 structure+area for X4 structure)}
SX4={area for X4 structure/(area for X1 structure+area for X2 structure+area for X3 structure+area for X4 structure)}
ST3={area for T3 structure/(area for X1 structure+area for X2 structure+area for X3 structure+area for X4 structure)}

Chemical shift values of silicon in the X1 structure, the X2 structure, the X3 structure, and the X4 structure are shown below.

An example of the X1 structure (Ri=Rj=—OC₂H₅, Rk=—CH₃): −47 ppm
An example of the X2 structure (Rg=—OC₂H₅, Rh=—CH₃): −56 ppm
An example of the X3 structure (Rf=—CH₃): −65 ppm

Further, a chemical shift value of silicon when the X4 structure is present is shown below.

X4 structure: −108 ppm

<Measurement of Average Thickness Dav. of Surface Layer of Toner Particle to be Measured by Observation of Cross-Section of Toner Particle Through Use of Transmission Electron Microscope (TEM)>

In the present invention, a cross-section of a toner particle is observed by the following method.

A specific method of observing a cross-section of a toner particle is as described below. Toner particles are sufficiently dispersed in an epoxy resin that is curable at normal temperature, and then the resultant is cured under an atmosphere of 40° C. for 2 days. A flake-like sample is cut out from the obtained cured product through use of a microtome including diamond teeth. The sample is magnified at a magnification of from 10,000 times to 100,000 times with a transmission electron microscope (TEM) (electron microscope Tecnai TF20XT manufactured by FEI Company), and cross-sections of the toner particles are observed.

In the present invention, the cross-sections are confirmed through use of: a difference in atomic weight between atoms in a resin and an organosilicon compound to be used; and the fact that contrast is increased when an atomic weight becomes larger. Further, in order to provide contrast between materials, a ruthenium tetroxide staining method and an osmium tetroxide staining method are used. The presence states of various elements in the toner particles may be identified through mapping of the various elements using a transmission electron microscope. A particle used in the measurement is determined as described below. A circle-equivalent diameter Dtem of a toner particle is determined based on its cross-section obtained from the TEM image, and when a value thereof falls within a width of ±10% of the weight-average particle diameter of the toner particles determined by a method described later, that particle is defined as the particle used in the measurement.

A light field image of a cross-section of a toner particle is acquired at an acceleration voltage of 200 kV through use of an electron microscope Tecnai TF20XT manufactured by FEI Company as described above. Next, an EF mapping image of a Si—K end (99 eV) is acquired by a Three Window method through use of an EELS detector GIF Tridiem manufactured by Gatan, Inc. to confirm that an organosilicon polymer exists in the surface layer. Then, the following observation is performed for one toner particle whose circle-equivalent diameter Dtem is included in the ±10% width of the weight-average particle diameter of the toner particles.

In the observation of a cross-section of the toner particle using a transmission electron microscope (TEM),

i) a chord providing the longest diameter of the cross-section of the toner particle is defined as a major axis L,
ii) one of the line segments when the major axis L is divided at its midpoint C is defined as a line segment a, and
iii) 32 line segments drawn from the midpoint C of the major axis L to the surface of the toner particle, the line segments being shifted in increments of 11.25° with reference to the line segment a, are defined as Arₙ (n=1 to 32), respectively (see FIG. 1).
Ar₁ is the line segment a.

Further, the lengths of the surface layer on Arₙ (n=1 to 32) are defined as FRAₙ (n=1 to 32).

An average thickness D₍ₙ₎ of the surface layer of one toner particle is calculated by the following equation. D₍ₙ₎=(total of FRAₙ (n=1 to 32))/32

In the present invention, for the purpose of averaging, ten toner particles were subjected to measurement, and an average value per toner particle was calculated.

In addition, the ratio of the number of dividing axes at which the thickness of the surface layer containing the organosilicon polymer of the toner particle is 5.0 nm or less is calculated as the ratio of line segments at which the thickness of the surface layer is 5.0 nm or less in the 32 line segments. Also in this case, the ratio is calculated for ten toner particles, and their average value is calculated.

“Circle-Equivalent Diameter (Dtem) Determined Based on Cross-Section of Toner Particle Obtained from Transmission Electron Microscope (TEM) Image”

A circle-equivalent diameter (Dtem) determined based on a cross-section of a toner particle obtained from a TEM image is determined by the following method. First, regarding one toner particle, a circle-equivalent diameter (Dtem) determined based on a cross-section of the toner particle obtained from a TEM image is determined by the following equation.

[Circle-equivalent diameter determined based on cross-section of toner particle obtained from TEM image (Dtem)]=(Ar₁+Ar₂+ . . . Ar₃₂)/16

Circle-equivalent diameters of the ten toner particles are determined, and an average value per toner particle is calculated as a circle-equivalent diameter (Dtem) determined based on a cross-section of a toner particle.

<Measurement of Weight-Average Particle Diameter (D4) and Number-Average Particle Diameter (D1) of Toner (Particles)>

The weight-average particle diameter (D4) and number-average particle diameter (D1) of the toner (particles) are calculated as described below. A precision particle size distribution measuring apparatus based on a pore electrical resistance method including a 100 μm aperture tube “Coulter Counter Multisizer 3” (trademark, manufactured by Beckman Coulter, Inc.), and dedicated software included therewith “Beckman Coulter Multisizer 3 Version 3.51” (manufactured by Beckman Coulter, Inc.) for setting measurement conditions and analyzing measurement data are used. The measurement is performed with the number of effective measurement channels of 25,000, and the measured data are analyzed to calculate the D4 and the D1.

An electrolyte aqueous solution prepared by dissolving special grade sodium chloride in ion-exchanged water so as to have a concentration of about 1 mass %, for example, “ISOTON II” (manufactured by Beckman Coulter, Inc.) can be used in the measurement.

The dedicated software is set as described below prior to the measurement and the analysis.

In the “change standard measurement method (SOM)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc.) is set as a Kd value. A threshold and a noise level are automatically set by pressing a “threshold/noise level measurement” button. In addition, a current is set to 1,600 μA, a gain is set to 2, and an electrolyte solution is set to ISOTON II, and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256, and a particle diameter range is set to the range of from 2 μm or more to 60 μm or less.

A specific measurement method is as described below.

(1) About 200 mL of the electrolyte aqueous solution is charged into a 250 mL round-bottom beaker made of glass dedicated for Multisizer 3. The beaker is set in a sample stand, and the electrolyte aqueous solution in the beaker is stirred with a stirrer rod at 24 rotations/sec in a counterclockwise direction. Then, dirt and bubbles in the aperture tube are removed by the “aperture flush” function of the dedicated software.

(2) About 30 mL of the electrolyte aqueous solution is charged into a 100 mL flat-bottom beaker made of glass. About 0.3 mL of a diluted solution prepared by diluting “Contaminon N” (10 mass % aqueous solution of a neutral detergent for washing a precision measuring device formed of a nonionic surfactant, an anionic surfactant, and an organic builder and having a pH of 7, manufactured by Wako Pure Chemical Industries, Ltd.) with ion-exchanged water by three mass fold is added as a dispersant to the electrolyte aqueous solution.

(3) An ultrasonic dispersing unit “Ultrasonic Dispension System Tetora 150” (manufactured by Nikkaki Bios Co., Ltd.) in which two oscillators each having an oscillatory frequency of 50 kHz are built so as to be out of phase by 180° and which has an electrical output of 120 W is prepared. The predetermined amount of ion-exchanged water is charged into the water tank of the ultrasonic dispersing unit. About 2 mL of the Contaminon N is charged into the water tank.

(4) The beaker in the section (2) is set in the beaker fixing hole of the ultrasonic dispersing unit, and the ultrasonic dispersing unit is operated. Then, the height position of the beaker is adjusted in order that the liquid level of the electrolyte aqueous solution in the beaker may resonate with an ultrasonic wave from the ultrasonic dispersing unit to the fullest extent possible.

(5) About 10 mg of the toner (particles) is gradually added to and dispersed in the electrolyte aqueous solution in the beaker in the section (4) under a state in which the electrolyte aqueous solution is irradiated with the ultrasonic wave. Then, the ultrasonic dispersion treatment is continued for an additional 60 seconds. The temperature of water in the water tank is appropriately adjusted so as to be 10° C. or more and 40° C. or less at the time of the ultrasonic dispersion.

(6) The electrolyte aqueous solution in the section (5) having dispersed therein the toner (particles) is dropped with a pipette to the round-bottom beaker in the section (1) placed in the sample stand, and the concentration of the toner (particles) to be measured is adjusted to about 5%. Then, measurement is performed until the particle diameters of 50,000 particles are measured.

(7) The measurement data is analyzed with the dedicated software included with the apparatus, and the weight-average particle diameter (D4) is calculated. An “average diameter” on the “analysis/volume statistics (arithmetic average)” screen of the dedicated software when the dedicated software is set to show a graph in a vol % unit is the weight-average particle diameter (D4). In addition, an “average diameter” on the “analysis/number statistics (arithmetic average)” screen of the dedicated software when the dedicated software is set to show a graph in a number % unit is the number-average particle diameter (D1).

<Measurement Method for Surface Free Energy>

The surface free energy of the surface of the magnetic toner was measured using the following apparatus in accordance with the instruction manual of the apparatus with probe liquids each having three known components of surface free energy (water, diiodomethane, and ethylene glycol) under the following conditions.

Specifically, the contact angle θ of each of the probe liquids on the surface of the magnetic toner was measured using a contact angle meter CA-X ROLL Model manufactured by Kyowa Interface Science Co., Ltd., and the surface free energy was determined using the equation of the Kitazaki-Hata theory.

(i) Detailed measurement conditions of the contact angle θ are as described below.

Measurement: drop method (circle fitting)
Liquid volume: 1 μL
Recognition of drop adhesion: automatic
Image processing: algorithm-no reflection
Image mode: frame
Threshold level: automatic

In addition, with regard to the contact angle θ, the measurement was performed 5 times each using each probe liquid, the average value of the 5 measured values was adopted as the contact angle θ of the probe liquid. For data analysis, FAMAS (manufactured by Kyowa Interface Science Co., Ltd.) was used.

A pellet was prepared from the toner using a press molding machine (manufactured by MAEKAWA Testing Machine Mfg Co., Ltd.) under the following conditions, and was subjected to measurement of surface free energy under the above-mentioned conditions.

Aluminum ring: diameter of 30 mm

### Toner: 4.1 g

Press pressure: 200 kgf
Press time: 3 minutes

<Measurement Method for Dielectric Loss Factor>

A 4284A precision LCR meter (manufactured by Keysight Technologies, Inc. (former name: Hewlett-Packard Company)) is used and calibrated at frequencies of 1 kHz and 1 MHz. After that, a complex dielectric constant at a frequency of 100 kHz is measured, and a dielectric loss factor ∈″ is calculated. Specifically, 1.0 g of the magnetic toner is weighed and molded into a disc-shaped measurement sample having a diameter of 25 mm and a thickness of 1 mm or less (preferably from 0.5 mm to 0.9 mm) by applying a load of 19,600 kPa (200 kg/cm²) for 2 minutes. The measurement sample is mounted onto ARES (manufactured by TA instruments (former name: Rheometric Scientific F.E. Ltd.)) having mounted thereonto a dielectric constant measuring jig (electrode) having a diameter of 25 mm, and is heated to a temperature of 80° C. to be melted and fixed. After that, the resultant is cooled to a temperature of 25° C., and then heated to 150° C. at a rate of temperature increase of 2° C./min while a measured value is acquired every 15 seconds at a constant frequency of 100 kHz under a state in which a load of 0.49 N (50 g) is applied. A dielectric loss factor (∈″) at a temperature of 30° C. is determined from the resultant measured values.

<Measurement of Melt Viscosity at 100° C.>

Measurement is performed under the following conditions using, as an apparatus, for example, a flow tester CFT-500D (manufactured by Shimadzu Corporation).

Sample: 1.0 g of the toner is weighed and molded by being pressed with a press molding machine having a diameter of 1 cm at a load of 20 kN for 1 minute to prepare a sample.

Die hole diameter: 1.0 mm

Die length: 1.0 mm

Cylinder pressure: 9.807×10⁵ (Pa)

Measurement mode: temperature increase method

Rate of temperature increase: 4.0° C./min

The viscosity (Pa·s) of the toner at from 50° C. to 200° C. is measured by the above-mentioned method to determine its melt viscosity (Pa·s) at 100° C.

<Measurement Method for Deformation Amount of Toner>

In a microcompression test, an ultra-micro hardness tester ENT1100 manufactured by Elionix Inc. was used. A flat indenter measuring 20 μm square was used as an indenter, and measurement was performed under a measurement environment having a temperature of 25° C. and a humidity of 60%. A load of up to a maximum load of 9.8×10⁻⁴ N was applied to one particle of the toner at an application rate of 9.8×10⁻⁵ N/sec. After the maximum load had been reached, the particle was left to stand under the load for 0.1 sec, and a deformation amount after the standing was measured.

<Measurement Method for Aspect Ratio>

The average circularity of the toner particles was measured under the same measurement and analysis conditions as those at the time of a calibration operation with a flow type particle image analyzer “FPIA-3000” (manufactured by Sysmex Corporation).

A specific measurement method is as described below. First, about 20 mL of ion-exchanged water from which an impure solid and the like have been removed in advance is charged into a container made of glass. About 0.2 mL of a dilution prepared by diluting “Contaminon N” (10 mass % aqueous solution of a neutral detergent for washing a precision measuring instrument containing a nonionic surfactant, an anionic surfactant, and an organic builder and having a pH of 7, manufactured by Wako Pure Chemical Industries, Ltd.) with ion-exchanged water by about 3 mass fold is added as a dispersant into the container. Further, about 0.02 g of a measurement sample is added, and the mixture is subjected to dispersion treatment with an ultrasonic dispersing device for 2 minutes to obtain a dispersion liquid for measurement. At that time, the dispersion liquid is appropriately cooled so as to have a temperature of 10° C. or more and 40° C. or less. A desktop ultrasonic washing device/dispersing device having an oscillatory frequency of 50 kHz and an electrical output of 150 W (e.g., “VS-150” (manufactured by Velvo-Clear)) is used as the ultrasonic dispersing device, and a predetermined amount of ion-exchanged water is charged into a water tank and about 2 mL of the Contaminon N is added into the water tank.

In the measurement, the flow type particle image analyzer having mounted thereonto “LUCPLFLN” (magnification: 20, numerical aperture: 0.40, manufactured by Olympus Corporation) as an objective lens was used, and a particle sheath “PSE-900A” (manufactured by Sysmex Corporation) was used as a sheath liquid. The dispersion liquid prepared in accordance with the above-mentioned procedure is introduced into the flow type particle image analyzer, and 2,000 toner particles were subjected to measurement according to the total count mode of an HPF measurement mode. Then, the aspect ratio of the toner particles was determined while a binarization threshold at the time of particle analysis was set to 85% and particle diameters to be analyzed were limited to ones each corresponding to a circle-equivalent diameter of 1.977 μm or more and less than 39.54 μm.

In the measurement, automatic focusing is performed with standard latex particles (obtained by, for example, diluting “RESEARCH AND TEST PARTICLES Latex Microsphere Suspensions 5100A” manufactured by Duke Scientific Corporation with ion-exchanged water) prior to the initiation of the measurement. After that, focusing is preferably performed every 2 hours from the initiation of the measurement.

In Examples of the present application, a flow type particle image analyzer which had been subjected to a calibration operation by Sysmex Corporation and had received a calibration certificate issued by Sysmex Corporation was used. Measurement was performed under the same measurement and analysis conditions as those at the time of the reception of the calibration certificate except that particle diameters to be analyzed were limited to ones each corresponding to a circle-equivalent diameter of 1.977 μm or more and less than 39.54 μm.

### EXAMPLES

The present invention is specifically described below by way of Production Examples and Examples. However, the present invention is by no means limited by Production Examples and Examples.

<Production of Magnetic Iron Oxide>

50 L of a ferrous sulfate aqueous solution containing Fe²⁺ at 2.0 mol/L was mixed with 55 L of a 4.0 mol/L sodium hydroxide aqueous solution, and the mixture was stirred to provide a ferrous salt aqueous solution containing a ferrous hydroxide colloid. The resultant aqueous solution was kept at 85° C. and subjected to an oxidation reaction while air was blown in at 20 L/min. Thus, a slurry containing core particles was obtained.

The resultant slurry was filtered with a filter press and washed, and then the core particles were redispersed in water to perform reslurrying. To the reslurry liquid, sodium silicate was added at 0.20 mass % in terms of silicon with respect to the core particles to adjust the pH of the slurry liquid to 6.0, and the resultant was stirred to provide magnetic iron oxide particles each having a silicon-rich surface. The resultant slurry was filtered with a filter press, washed, and further reslurried with ion-exchanged water. To the reslurry liquid (solid content: 50 g/L), 500 g (10 mass % with respect to magnetic iron oxide) of an ion-exchange resin SK110 (manufactured by Mitsubishi Chemical Corporation) was added, and the mixture was stirred for 2 hours to perform ion exchange. After that, the ion-exchange resin was removed by filtration with a mesh, and the filtrate was filtered with a filter press and washed, and dried and disintegrated to provide magnetic iron oxide having a number-average diameter of primary particles of 190 nm.

<Production of Silane Compound 1>

30 Parts by mass of iso-butyltrimethoxysilane was added dropwise to 70 parts by mass of ion-exchanged water under stirring. After that, the aqueous solution was kept at a pH of 5.5 and a temperature of 55° C., and subjected to hydrolysis by being dispersed using a disper blade at a circumferential speed of 0.46 m/s for 120 minutes. After that, the pH of the aqueous solution was adjusted to 7.0, followed by cooling to 10° C. to terminate the hydrolysis reaction. Thus, a silane compound aqueous solution 1 containing a hydrolysate was obtained.

<Production of Silane Compound 2>

A silane compound aqueous solution 2 was produced in the same manner as in the production of the silane compound 1 except that iso-butyltrimethoxysilane was changed to n-hexyltrimethoxysilane.

<Production of Magnetic Material 1>

100 Parts by mass of the magnetic iron oxide was loaded into a high-speed mixer (Model LFS-2 manufactured by Earthtechnica Co., Ltd. (former name: Fukae Powtec Co., Ltd.)), and 8.0 parts by mass of the silane compound aqueous solution 1 was added dropwise over 2 minutes under stirring at a number of revolutions of 2,000 rpm. After that, the contents were mixed and stirred for 5 minutes. Next, in order to stick the silane compound, the mixture was dried at 40° C. for 1 hour to reduce its water content, and then the mixture was dried at 110° C. for 3 hours to allow a condensation reaction of the silane compound to proceed. After that, the resultant was disintegrated and passed through a sieve having an opening of 100 μm to provide a magnetic material 1.

<Production of Magnetic Material 2>

A magnetic material 2 was produced in the same manner as in the production of the magnetic material 1 except that the silane compound aqueous solution 1 was changed to the silane compound aqueous solution 2.

<Production Example of Toner 1>

A four-necked vessel with a reflux condenser, a stirring machine, a temperature gauge, and a nitrogen inlet tube was loaded with 720 parts by mass of ion-exchanged water and 450 parts by mass of a 0.1 mol/L-Na₃PO₄ aqueous solution, and the temperature was increased to 60° C. After that, 67.7 parts by mass of a 1.0 mol/L-CaCl₂ aqueous solution was added to provide an aqueous medium containing a dispersion stabilizer.

(Dispersion Step)

| | |
|---|---|
| Styrene | 80.0 parts by mass |
| n-butyl acrylate | 20.0 parts by mass |
| Methyltriethoxysilane | 10.0 parts by mass |
| Divinylbenzene | 0.65 part by mass |
| Magnetic material 1 | 50.0 parts by mass |
| Magnetic material 2 | 50.0 parts by mass |
| Negative charge control agent T-77 | 1.5 parts by mass |
| (manufactured by | |
| Hodogaya Chemical Co., Ltd.) | |
| Polyester resin | 3.0 parts by mass |

(polyester resin obtained by a condensation reaction between an ethylene oxide adduct of bisphenol A and terephthalic acid; Mn=5,000, acid value=6 mgKOH/g, Tg=68° C.)

The above-mentioned materials were mixed using Cavitron (manufactured by Eurotec) at a circumferential speed of a rotator of 35 m/s for 2 hours to provide a magnetic material-dispersed monomer having a magnetic material dispersed in a polymerizable monomer.

(Preparation Step)

| | |
|---|---|
| Behenyl behenate (melting point Tm: 72.1° C.) | 10.0 parts by mass |

The temperature of the magnetic material-dispersed monomer obtained in the dispersion step was increased to 65° C., the above-mentioned releasing agent (behenyl behenate) was added, and mixing treatment was performed using Cavitron (manufactured by Eurotec) at a circumferential speed of a rotator of 35 m/s for 1 hour to provide a polymerizable monomer composition 1.

After that, to the polymerizable monomer composition 1, 10.0 parts by mass of t-butyl peroxypivalate (50 mass % toluene solution) serving as a polymerization initiator was added. The polymerizable monomer composition 1 having added thereto the polymerization initiator was loaded into an aqueous medium, and granulated at 60° C. under a N₂ atmosphere for 12 minutes while the number of revolutions of a high-speed stirring device T.K. homomixer (manufactured by Primix Corporation (former name: Tokushu Kika Kogyo Co., Ltd.)) was maintained at 12,500 rpm.

After that, the high-speed stirring device was replaced by a propeller type stirrer, and the internal temperature was increased to 70° C., and the resultant was allowed to react for 5 hours under slow stirring. At this time, the pH of the aqueous medium was 5.1. Next, 10.0 parts by mass of a 1.0 mol/L-NaOH aqueous solution was added to adjust the pH to 8.0, and the temperature in the vessel was increased to 90° C. and kept for 7.5 hours. After that, 4.0 parts by mass of 10% hydrochloric acid was added to 50 parts by mass of ion-exchanged water to adjust the pH to 5.1. Next, 300 parts by mass of the ion-exchanged water was added, the reflux condenser was removed, and a distillation device was mounted onto the vessel. Distillation was performed at a temperature of 100° C. for 5 hours to provide a polymer slurry 1. 300 Parts by mass of a distillation fraction was obtained.

After cooling to 30° C., dilute hydrochloric acid was added into the vessel containing the polymer slurry 1 to remove the dispersion stabilizer. Further, the resultant was separated by filtration, washed, and dried to provide toner particles 1. The resultant toner particles 1 had a weight-average particle diameter of 7.7 μm. The formulation of the toner particles 1 and conditions are shown in Table 1, and their physical properties are shown in Table 3.

The toner particles 1 were subjected to TEM observation and silicon mapping. As a result, it was found that silicon atoms were uniformly present in their surface layers. Also in each of the following Examples and Comparative Examples, a surface layer containing an organosilicon polymer was similarly identified by silicon mapping.

<Production Examples of Toner Particles 2 to 14>

Toner particles 2 to 14 were obtained in the same manner as in the production example of the toner particles 1 except that the formulation and the conditions were changed to those shown in Table 1. In the production of the toner particles 11 to 14, the following changes were made in addition to the changes shown in Table 1.

Toner particles 11: The circumferential speed of the rotator of Cavitron was changed from 35 m/s to 40 m/s.
Toner particles 12: Cavitron was changed to Dissolver (manufactured by M Technique Co., Ltd.), and the number of revolutions was changed to 500 r/min.
Toner particles 13: The circumferential speed of the rotator of Cavitron was changed from 35 m/s to 40 m/s.
Toner particles 14: Cavitron was changed to Dissolver (manufactured by M Technique Co., Ltd.), and the number of revolutions was changed to 500 r/min.

Physical properties of the resultant toner particles are shown in Table 3. In addition, the toner particles 2 to 14 were subjected to TEM observation and silicon mapping. As a result, it was found that silicon atoms were uniformly present in their surface layers.

The toner particles 1 to 14 were used as they were as toners 1 to 14 without being subjected to external addition treatment.

<Production Example of Comparative Toner Particles 1>

The amount of methyltriethoxysilane used in the production example of the toner particles 1 was changed from 10 parts by mass to 1 part by mass. Further, Cavitron (manufactured by Eurotec) used in each of the dispersion step and the preparation step was changed to Dissolver (manufactured by M Technique Co., Ltd.) and the number of revolutions was changed to 500 r/min. Furthermore, the revolution number of stirring of TK type homomixer was changed to 7,500 rpm. Except for the foregoing, comparative toner particles 1 were obtained in the same manner as in the production example of the toner particles 1. The formulation of the comparative toner particles 1 is shown in Table 2, and their physical properties are shown in Table 4. The comparative toner particles 1 were subjected to TEM observation and silicon mapping. As a result, it was found that a small amount of silicon atoms was present in their surface layers.

The comparative toner particles 1 were used as they were as a comparative toner 1 without being subjected to external addition treatment.

<Production Example of Comparative Toner Particles 2>

In the production example of the comparative toner particles 1, a change was made so that 1 part by mass of methyltriethoxysilane was not used, and moreover, the amount of divinylbenzene was changed from 0.65 part by mass to 0.90 part by mass. Except for the foregoing, comparative toner particles 2 were produced in the same manner.

With respect to 100 parts by mass of the comparative toner particles 2, 0.3 part by mass of hydrophobic silica (BET specific surface area: 200 m²/g, one subjected to hydrophobizing treatment with 3.0 mass % of hexamethyldisilazane and 3 mass % of a silicone oil having a viscosity of 100 cps) was mixed using Mitsui Henshell Mixer (manufactured by Nippon Coke & Engineering Co., Ltd. (former name: Mitsui Mining Co., Ltd.)) to prepare a comparative toner 2. The formulation of the comparative toner particles 2 is shown in Table 2, and physical properties of the comparative toner 2 are shown in Table 4.

<Production Example of Comparative Toner Particles 3>

Comparative toner particles 3 were obtained in the same manner as in the production example of the comparative toner particles 2 except that the amount of divinylbenzene was changed from 0.90 part by mass to 0.65 part by mass.

In addition, a comparative toner 3 was prepared by performing external addition in the same manner as in the external addition step in the production example of the comparative toner particles 2 except that the addition amount of hydrophobic silica was changed from 0.3 part by mass to 3.0 parts by mass. The formulation of the comparative toner particles 3 is shown in Table 2, and their physical properties are shown in Table 4.

<Production Example of Comparative Toner Particles 4>

Comparative toner particles 4 were obtained in the same manner as in the production example of the comparative toner particles 3 except that the amount of divinylbenzene was changed from 0.65 part by mass to 0.90 part by mass.

In addition, a comparative toner 4 was prepared by performing external addition in the same manner as in the external addition step in the production example of the comparative toner particles 3. The formulation of the comparative toner particles 4 is shown in Table 2, and their physical properties are shown in Table 4.

<Evaluation Machine 1>

A printer LBP3100 manufactured by Canon Inc. was modified and used for image output evaluation. The modification was as described below. As illustrated in FIG. 4B, the toner bearing member (FIG. 4B; 102) was brought into contact with the electrostatic latent image bearing member (FIG. 4B; 100). The outer diameter of the toner bearing member was reduced from 10 mm to 8 mm, and the abutting pressure was adjusted so that the abutting portion of the electrostatic latent image bearing member had a width of 0.8 mm. In addition, the diameter of the toner bearing member was reduced to reduce the area of the abutting portion between the toner bearing member and the regulating portion. Further, the printing speed was adjusted from 16 sheets/min to 30 sheets/min.

<Evaluation Machine 2>

In addition to the modification of the evaluation machine 1, the cleaning unit (FIG. 4B: 116) was removed.

### Example 1

The evaluation machine 1 and the evaluation machine 2 were each loaded with 150 g of the toner 1. Under a high-temperature and high-humidity environment (32.5° C./85% RH), image output was performed on 5,000 sheets in an intermittent mode repeating printing out a horizontal line having a print percentage of 1% on 2 sheets, followed by a stop for 6 seconds, and evaluations of a ghost image and fogging described below were performed. The results obtained using the evaluation machine 1 are shown in Table 5, and the results obtained using the evaluation machine 2 are shown in Table 6.

In addition, an evaluation of long-term storage stability was performed using the toner 1, and an evaluation of low-temperature fixability described below was performed using the evaluation machine 1. The results of the evaluations are shown in Table 5.

<Ghost>

After printing out of 5,000 sheets, a plurality of solid images each measuring 10 mm×10 mm were printed out, and then a halftone image of 2 dots and 3 spaces was printed out. In the halftone image portion, a portion subjected to the influence of the solid images and a portion not subjected to the influence were each measured for its image density, and evaluation was performed using the difference between the image densities. The image densities were measured using a Macbeth reflection densitometer (manufactured by Gretag Macbeth).

A: The density difference is less than 0.02.
B: The density difference is 0.02 or more and less than 0.05.
C: The density difference is 0.05 or more and less than 0.10.
D: The density difference is 0.10 or more and less than 0.20.
E: The density difference is 0.20 or more.

<Fogging>

After printing out of 5,000 sheets, a solid white image was output, and its reflectance was measured using REFLECTOMETER MODEL TC-6DS manufactured by Tokyo Denshoku Co., Ltd. Meanwhile, the reflectance of transfer paper (standard paper) before the formation of the white image was similarly measured. As a filter, a green filter was used. Fogging was calculated from the reflectances before and after the output of the white image using the following equation.

Fogging (reflectance) (%)=reflectance of standard paper (%)−reflectance of solid white image sample (%)

Criteria for the fogging are as follows.

A: Less than 1.0%
B: 1.0% or more and less than 2.0%
C: 2.0% or more and less than 3.0%
D: 3.0% or more and less than 4.0%
E: 4.0% or more

<Long-Term Storage Stability>

10 g of the toner 1 was loaded into a 100 mL glass bottle and left to stand under a temperature of 45° C. and a humidity of 95% for 3 months, followed by judgment based on visual observation.

A: No change is found.
B: A fine aggregate is found.
C: A conspicuous aggregate is found, but is readily loosened.
D: An aggregate which is difficult to loosen occurs.
E: Conspicuous caking occurs.

<Low-Temperature Fixability>

Low-temperature fixability is evaluated as described below. Image output is performed at a preset temperature of 200° C. on FOX RIVER BOND paper while a halftone image density is adjusted so that an image density measured with a Macbeth reflection densitometer (manufactured by Gretag Macbeth) may be from 0.75 to 0.80.

After that, image output was performed while the preset temperature of the fixing unit was lowered from 210° C. by increments of 5° C. After that, the fixed image was rubbed 10 times with lens-cleaning paper having applied thereto a load of 5.4 kPa (55 g/cm²), and the temperature at which the density reduction ratio of the fixed image after the rubbing exceeded 10% was defined as a fixation lower limit temperature. As the temperature becomes lower, the toner is more excellent in low-temperature fixability. Evaluation was performed in accordance with the following criteria.

A: Less than 160° C.
B: 160° C. or more and less than 170° C.
C: 170° C. or more and less than 185° C.
D: 185° C. or more and less than 200° C.
E: 200° C. or more

### Examples 2 to 14

Evaluation was performed in the same manner as in Example 1 except that the toners 2 to 14 were used. The results obtained using the evaluation machine 1 are shown in Table 5, and the results obtained using the evaluation machine 2 are shown in Table 6.

### Comparative Examples 1 to 4

Evaluation was performed in the same manner as in Example 1 except that the comparative toners 1 to 4 were used. The results obtained using the evaluation machine 1 are shown in Table 5, and the results obtained using the evaluation machine 2 are shown in Table 6.

TABLE 1

| | | | | | Stirring device | Revolution |
|---|---|---|---|---|---|---|
| | | Magnetic | Magnetic | | used in | number of |
| | | material 1 | material 2 | Divinylbenzene | dispersion step | stirring of TK |
| Toner particles | Methylethoxysilane | (part(s) by | (part(s) by | (part(s) by | and preparation | type homomixer |
| No. | (part(s) by mass) | mass) | mass) | mass) | step | (rpm) |
| Toner particles 1 | 10 | 50 | 50 | 0.65 | Cavitron | 12,500 |
| Toner particles 2 | 8 | 50 | 50 | 0.65 | Cavitron | 12,500 |
| Toner particles 3 | 12 | 50 | 50 | 0.65 | Cavitron | 12,500 |
| Toner particles 4 | 10 | 50 | 50 | 0.55 | Cavitron | 12,500 |
| Toner particles 5 | 15 | 50 | 50 | 0.65 | Cavitron | 12,500 |
| Toner particles 6 | 15 | 50 | 50 | 0.75 | Cavitron | 12,500 |
| Toner particles 7 | 5 | 50 | 50 | 0.65 | Cavitron | 12,500 |
| Toner particles 8 | 5 | 50 | 50 | 0.55 | Cavitron | 12,500 |
| Toner particles 9 | 5 | 50 | 50 | 0.75 | Cavitron | 12,500 |
| Toner particles 10 | 5 | 50 | 50 | 0.55 | Cavitron | 7,500 |
| Toner particles 11 | 5 | 60 | 60 | 0.55 | Cavitron | 7,500 |
| Toner particles 12 | 5 | 100 | 0 | 0.55 | Dissolver | 7,500 |
| Toner particles 13 | 5 | 70 | 70 | 0.55 | Cavitron | 7,500 |
| Toner particles 14 | 5 | 80 | 0 | 0.55 | Dissolver | 7,500 |

TABLE 2

| | | | | | Stirring device | Revolution |
|---|---|---|---|---|---|---|
| | | Magnetic | Magnetic | | used in | number of |
| | | material 1 | material 2 | Divinylbenzene | dispersion step | stirring of TK |
| | Methyltriethoxysilane | (part(s) by | (part(s) by | (part(s) by | and preparation | type homomixer |
| Toner particles No. | (part(s) by mass) | mass) | mass) | mass) | step | (rpm) |
| Comparative toner | 1 | 50 | 50 | 0.65 | Dissolver | 7,500 |
| particles 1 | | | | | | |
| Comparative toner | 0 | 50 | 50 | 0.90 | Dissolver | 7,500 |
| particles 2 | | | | | | |
| Comparative toner | 0 | 50 | 50 | 0.65 | Dissolver | 7,500 |
| particles 3 | | | | | | |
| Comparative toner | 0 | 50 | 50 | 0.90 | Dissolver | 7,500 |
| particles 4 | | | | | | |

TABLE 3

| | | | | | | Average thickness | |
|---|---|---|---|---|---|---|---|
| | Deformation | Surface free | Melt viscosity | | Dielectic | of surface layer | |
| Toner | amount | energy | η′ | Aspect | loss factor | Dav. | ST3 |
| No. | (μm) | (mJ/m²) | (Pa · s) | ratio | (pF/m) | (nm) | (%) |
| Toner 1 | 1.5 | 10.5 | 3.5 × 10⁴ | 0.91 | 0.15 | 30.3 | 70 |
| Toner 2 | 2.0 | 15.6 | 2.9 × 10⁴ | 0.91 | 0.15 | 27.5 | 65 |
| Toner 3 | 1.3 | 8.3 | 3.3 × 10⁴ | 0.91 | 0.15 | 32.2 | 72 |
| Toner 4 | 3.0 | 10.1 | 5.0 × 10³ | 0.91 | 0.15 | 30.5 | 70 |
| Toner 5 | 1.0 | 5.0 | 3.2 × 10⁴ | 0.91 | 0.15 | 33.4 | 78 |
| Toner 6 | 0.7 | 5.3 | 1.0 × 10⁵ | 0.91 | 0.15 | 34.0 | 78 |
| Toner 7 | 2.5 | 19.8 | 3.3 × 10⁴ | 0.91 | 0.15 | 23.2 | 56 |
| Toner 8 | 2.9 | 20.0 | 5.2 × 10³ | 0.91 | 0.15 | 24.5 | 54 |
| Toner 9 | 2.8 | 19.2 | 9.0 × 10⁴ | 0.91 | 0.15 | 25.0 | 55 |
| Toner 10 | 3.0 | 19.8 | 5.4 × 10³ | 0.88 | 0.15 | 23.3 | 55 |
| Toner 11 | 3.0 | 19.6 | 5.2 × 10³ | 0.90 | 0.05 | 24.2 | 54 |
| Toner 12 | 2.9 | 19.9 | 5.0 × 10³ | 0.88 | 0.25 | 26.4 | 56 |
| Toner 13 | 2.9 | 19.5 | 5.3 × 10³ | 0.90 | 0.05 | 23.8 | 55 |
| Toner 14 | 3.0 | 19.8 | 5.1 × 10³ | 0.88 | 0.40 | 25.6 | 55 |

TABLE 4

| | | | | | | Average thickness | |
|---|---|---|---|---|---|---|---|
| | Deformation | Surface free | Melt viscosity | | Dielectric | of surface layer | |
| | amount | energy | η′ | Aspect | loss factor | Dav. | ST3 |
| Toner No. | (μm) | (mJ/m²) | (Pa · s) | ratio | (pF/m) | (nm) | (%) |
| Comparative toner 1 | 3.8 | 28.8 | 3.0 × 10⁴ | 0.88 | 0.16 | 2.6 | 32 |
| Comparative toner 2 | 3.0 | 42.2 | 9.5 × 10⁴ | 0.87 | 0.14 | — | — |
| Comparative toner 3 | 4.2 | 15.5 | 3.4 × 10⁴ | 0.88 | 0.14 | — | — |
| Comparative toner 4 | 1.1 | 14.2 | 7.8 × 10⁵ | 0.89 | 0.15 | — | — |

TABLE 5

| | | | | Long-term | Low- |
|---|---|---|---|---|---|
| | | | | storage | temperature |
| | | Ghost | Fogging | stability | fixability |
| Example 1 | Toner particles 1 | A (0) | A (0.3%) | A | A (150° C.) |
| Example 2 | Toner particles 2 | A (0) | A (0.6%) | A | A (150° C.) |
| Example 3 | Toner particles 3 | A (0) | A (0.7%) | A | A (150° C.) |
| Example 4 | Toner particles 4 | B (0.02) | B (1.1%) | B | A (145° C.) |
| Example 5 | Toner particles 5 | A (0) | A (0.5%) | C | A (150° C.) |
| Example 6 | Toner particles 6 | A (0) | A (0.4%) | B | B (160° C.) |
| Example 7 | Toner particles 7 | B (0.03) | B (1.5%) | B | A (150° C.) |
| Example 8 | Toner particles 8 | B (0.03) | B (1.4%) | C | A (150° C.) |
| Example 9 | Toner particles 9 | B (0.04) | B (1.8%) | B | B (165° C.) |
| Example 10 | Toner particles 10 | C (0.05) | B (1.7%) | C | A (145° C.) |
| Example 11 | Toner particles 11 | C (0.06) | C (2.5%) | C | A (150° C.) |
| Example 12 | Toner particles 12 | C (0.06) | C (2.5%) | C | A (150° C.) |
| Example 13 | Toner particles 13 | C (0.07) | C (2.5%) | C | A (150° C.) |
| Example 14 | Toner particles 14 | C (0.07) | C (2.8%) | C | A (150° C.) |
| Comparative Example 1 | Comparative toner particles 1 | D (0.11) | D (3.2%) | C | B (160° C.) |
| Comparative Example 2 | Comparative toner particles 2 | D (0.13) | D (3.7%) | D | E (210° C.) |
| Comparative Example 3 | Comparative toner particles 3 | D (0.15) | D (3.8%) | D | C (170° C.) |
| Comparative Example 4 | Comparative toner particles 4 | C (0.05) | B (1.2%) | E | E (205° C.) |

TABLE 6

| | | Ghost | Fogging |
|---|---|---|---|
| Example 1 | Toner particles 1 | A (0) | A (0.6%) |
| Example 2 | Toner particles 2 | B (0.02) | A (0.8%) |
| Example 3 | Toner particles 3 | A (0) | B (1.4%) |
| Example 4 | Toner particles 4 | B (0.02) | B (1.2%) |
| Example 5 | Toner particles 5 | B (0.03) | A (0.8%) |
| Example 6 | Toner particles 6 | B (0.04) | A (0.7%) |
| Example 7 | Toner particles 7 | C (0.05) | B (1.8%) |
| Example 8 | Toner particles 8 | C (0.06) | B (1.8%) |
| Example 9 | Toner particles 9 | C (0.06) | C (2.4%) |
| Example 10 | Toner particles 10 | C (0.06) | C (2.7%) |
| Example 11 | Toner particles 11 | C (0.07) | C (2.5%) |
| Example 12 | Toner particles 12 | C (0.08) | C (2.8%) |
| Example 13 | Toner particles 13 | C (0.09) | C (2.8%) |
| Example 14 | Toner particles 14 | C (0.09) | C (2.9%) |
| Comparative | Comparative toner | D (0.14) | D (3.5%) |
| Example 1 | particles 1 | | |
| Comparative | Comparative toner | E (0.22) | E (4.5%) |
| Example 2 | particles 2 | | |
| Comparative | Comparative toner | D (0.15) | E (4.8%) |
| Example 3 | particles 3 | | |
| Comparative | Comparative toner | C (0.09) | C (2.6%) |
| Example 4 | particles 4 | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-129382, filed Jun. 29, 2015, which is hereby incorporated by reference herein in its entirety.

What is claimed is:

1. A magnetic toner, comprising magnetic toner particles each containing a binder resin and a magnetic material,
wherein a deformation amount when a load of 9.8×10⁻⁴ N is applied to one particle of the magnetic toner in a microcompression test is 3.0 μm or less,
wherein the magnetic toner has a surface free energy of 5 mJ/m² or more and 20 mJ/m² or less, and
wherein the magnetic toner has a melt viscosity η′ at 100° C. of 5.0×10³ Pa·s or more and 1.0×10⁵ Pa·s or less.

2. The magnetic toner according to claim 1, wherein the magnetic toner has an aspect ratio of 0.88 or more and 1.00 or less.

3. The magnetic toner according to claim 1, wherein the magnetic toner has a dielectric loss factor (∈″) at a frequency of 100 kHz and a temperature of 30° C. of 0.05 pF/m or more and 0.25 pF/m or less.

4. An image forming method, comprising:
a charging step of charging a surface of an electrostatic latent image bearing member with a contact type charging roller;
an image exposing step of exposing the charged surface of the electrostatic latent image bearing member to form an electrostatic latent image;
a developing step of developing the electrostatic latent image with a magnetic toner to form a toner image;
a transfer step of transferring the toner image onto a transfer material through or without through an intermediate transfer member; and
a fixing step of fixing the toner image, transferred onto the transfer material, onto the transfer material,
the magnetic toner comprises magnetic toner particles each containing a binder resin and a magnetic material,
wherein a deformation amount when a load of 9.8×10⁻⁴ N is applied to one particle of the magnetic toner in a microcompression test is 3.0 μm or less,
wherein the magnetic toner has a surface free energy of 5 mJ/m² or more and 20 mJ/m² or less, and
wherein the magnetic toner has a melt viscosity η′ at 100° C. of 5.0×10³ Pa·s or more and 1.0×10⁵ Pa·s or less.

5. The image forming method according to claim 4, wherein the image forming method is free of a cleaning step of removing a residual toner present on the surface of the electrostatic latent image bearing member after the transfer step and before the charging step, and the residual toner is collected in the developing step.

6. An image forming apparatus, comprising:
a magnetic toner;
an electrostatic latent image bearing member;
a contact type charging roller configured to charge the electrostatic latent image bearing member;
an image exposing device configured to form an electrostatic latent image on a charged surface of the electrostatic latent image bearing member;
a developing device configured to develop the electrostatic latent image with the magnetic toner to form a toner image;
a transfer device configured to transfer the toner image onto a transfer material through or without through an intermediate transfer member; and
a fixing device configured to fix the toner image, transferred onto the transfer material, onto the transfer material,
wherein the magnetic toner comprises magnetic toner particles each containing a binder resin and a magnetic material,
wherein a deformation amount when a load of 9.8×10⁻⁴ N is applied to one particle of the magnetic toner in a microcompression test is 3.0 μm or less,
wherein the magnetic toner has a surface free energy of 5 mJ/m² or more and 20 mJ/m² or less, and
wherein the magnetic toner has a melt viscosity η′ at 100° C. of 5.0×10³ Pa·s or more and 1.0×10⁵ Pa·s or less.

7. The image forming apparatus according to claim 6, wherein the image forming apparatus is free of a cleaning device configured to remove a residual toner on the electrostatic latent image bearing member in a region downstream of the transfer device and upstream of the contact type charging roller along the surface of the electrostatic latent image bearing member.
